(19) United States
(12) Patent Application Publication
(10) Pub. No.: US 2011/0158858 A1
(43) Pub. Date: Jun. 30, 2011

(54) WASTE TO LIQUID HYDROCARBON REFINERY SYSTEM

(76) Inventor: Mário Luis Alves Ramalho Gomes, Cabo Da Praia Acores (PT)

(21) Appl. No.: 12/596,598

(22) PCT Filed: Apr. 18, 2007
(86) PCT No.: PCT/PT2007/000018

§ 371 Date: Apr. 19, 2010

(51) Int. Cl. B01J 8/00

(52) U.S. Cl. 422/187

(57) ABSTRACT

A Waste to Liquid Hydrocarbon Refinery System that transforms any municipal solid wastes and hazardous industrial wastes, Biomass or any carbon containing feedstock into synthetic hydrocarbon, particularly, but not exclusively, diesel and gasoline and/or electricity and co-generated heat, comprising three major subsystems: i) the Pyro-Electric Thermal Converter (PETC) (10) and Plasma Arc (PA) waste and biomass gasification subsystem (1); ii) the hydrocarbon synthesis subsystem (2); and iii) the electricity generation and heat co-generation subsystem (3).

### 1—PRIOR ART

The starting point configuration is a Conventional Gas to Liquid (GTL) or a Coal to Liquid (CTL) Refinery system where, respectively, Natural Gas (methane) or coal is submitted to a gasification process to produce SYNGAS (Synthetic GAS) (hydrogen and carbon monoxide). SYNGAS is then used to synthesise liquid hydrocarbon species using a Fischer-Tropsch (FT) reactor, eventually combined with a distillation column and an hydrocracking reactor. Such conventional refinery systems do not allow mixed feedstock types and have a typical 6:1 yield of synthetic fuel (i.e. 1 ton of Natural Gas or Coal will allow the production of about 0.17 ton of FT products). Companies like Syntroleum, MossGas and Shell are engaged with GTL technologies. Companies like Sasol and Rentech are particularly engaged with CTL process, but deal also with GTL. Furthermore, ExxonMobil, Marathon and ConocoPhillips are announcing future investments in new GTL facilities.

Oil and fuel prices have created a compelling economic scenario both for GTL and CTL projects. Many countries are seeking ways to increase revenue from its gas and/or coal reserves. However, since GTL has Natural Gas as its feedstock and CTL uses coal, despite its recognised advantages relatively to fossil crude oil, the point is that either via GTL or CTL we will not acquire freedom and independence from fossil fuels. This means also that current GTL and CTL units will not prevent Global Climate Change.

Technically the gasification step required for GTL and CTL systems have to be modified to deal with new feedstocks like waste and renewable biomass, while the Fischer-Tropsch hydrocarbon synthesis step requires better yields than the present 6:1 in order to achieve economical viability. Furthermore, conventional GTL and CTL units have a carbon conversion ratio not better than 65%, i.e. 35% of the whole carbon contained in the original feedstock (natural gas (NG) or Coal) will not be transformed into FT products (it will be lost as carbon dioxide into the atmosphere).

The Choren Group has been involved in setting up a synthetic biofuel business based on a proprietary gasification technology, the Carbo-V® gasification, while its FT synthesis solution is based on the Shell GTL technology. Choren gasification process is able to deal with relatively clean biomass, mainly pre-processed wood and alike biomass feedstocks (Biomass to Liquid—BTL). Choren gasification system is not able to deal with Municipal or Hazardous Waste feedstocks (MSW or HW) or other diversified carbon containing feedstocks. Choren BTL expected yield is similar to Shell's one, that is 6:1.

The conventional GTL (100) or CTL (200) (FIG. 1) systems are composed of a gasification unit ((101) steam/methane reforming in the GTL case and steam/coal gasification (201) in the CTL case), where the SYNGAS (300) is generated. Proceeding downstream, the SYNGAS will be cooled (400), quenched and scrubbed (500) (the resulting waste water (501) is removed for further decontamination) and the cleaner SYNGAS (600) is compressed (1100) and injected at the Fischer-Tropsch reactor (700) for synthetic crude generation. The resulting synthetic hydrocarbons will proceed to a fractionate distillation column (800) for diesel (910) and naphtha (920) separation, while the heavier waxes will be further submitted to hydrocracking (900) to further produce more diesel and naphtha. The steam (2000) generated at the FT process is reused at the gasification step, while steam (3000) resulting from SYNGAS cooling can be used in a Rankine cycle steam turbine (1000) (with condenser (3100)) to produce electricity at a generator (1001) to be sold to the electrical utility grid. Unreacted Tail Gas (4000) is reinjected (4002) at the GTL gasification (101), after removing its CO₂ (4001).

The GTL stoichiometric ratio of H₂ to CO in the produced SYNGAS is such that an H₂ excess exists, that can be used (103), together with part of the NG and atmospheric O₂ (104), to deliver heat to the reformer via combustion. So part of the NG feedstock will not result in SYNGAS, which means that a significant percentage (around 30%) of the initial C in feedstock will not be converted into synthetic hydrocarbon products. In the CTL case, there is a stoichiometric deficit of H₂ relatively to CO. The conventional solution is to remove C (as CO₂) in order to increase the H₂/CO ratio. Furthermore, if hydrocracking is to be used after distillation, hydrogen will be required. In the GTL case it can be diverted from the SYNGAS stream (105), but for the CTL case, usually parallel coal gasification is produced (although in a smaller scale) to generate the required H₂.

Clearly, the conventional GTL and CTL systems tend to loose C to build the adequate stoichiometric H₂/CO ratio for the FT reactor. This is the main reason why only a maximum typical yield of 6:1 of useful synthetic fuels can be achieved with the conventional systems.

Another major concern with conventional GTL, CTL and even with BTL systems is the best achievable SYNGAS purity, in order to avoid catalyst poisoning.

### 2—SUMMARY OF THE INVENTION

The present document describes a system that is able to produce synthetic hydrocarbon fuels using any carbon containing feedstock. This is a synthetic and renewable hydrocarbon fuel production refinery. If the carbon containing feedstock is of renewable origin, like any type of biomass, then the resulting hydrocarbon fuel will be a renewable one. If the carbon containing feedstock is any type of non-biomass waste, either municipal or industrial (hazardous or not) the final hydrocarbon fuel will be not a renewable one, but the potential problem of environment contamination will be solved by the present system, while a high value product is generated. The present refinery system—Waste to Liquid Hydrocarbon Refinery System (WTLH)—is able to process any kind of waste with all gaseous, liquid or solid emissions well below the maximum limits imposed by the EU—Directive 2000/76/CE of the European Parliament for the incineration case.

The new WTLH refinery is an integrated system comprising i) a two stage feedstock gasification system for SYNGAS production (CO and H₂) at a molten iron bed reactor in the first stage and a plasma arc cyclone reactor in the second one, ii) a SYNGAS cooling and cleaning (scrubbing, quenching and ZnO and active C filtering) reactors where, respectively, heat and contaminants are removed from SYNGAS, iii) a Fischer-Tropsch reactor to convert SYNGAS into synthetic hydrocarbon crude, iv) a distillation and hydrocracking units where synthetic diesel and gasoline will be fractionate as major output products. Superheated steam will be produced both at the SYNGAS cooling unit and at the FT reactor. It will be used to feed a steam turbine for electrical power generation. The produced electricity is enough to satisfy the whole auto-consumption needs, with an excess available to be sold to the grid. The whole system yields are optimised to maximise synthetic diesel, gasoline and electricity production. That can be achieved using several strategies like i) stoichiometric injection of renewable hydrogen into the SYNGAS stream, ii) stoichiometric injection of hydrogen at the wax hydrocracking stage, iii) injection of renewable biogas as working fluid for the plasma arc torches, iv) steam generation at the SYNGAS cooling stage and at the FT reactor for steam turbine feeding, v) full recycling of non-reacted SYNGAS, vi) dissociation of locally produced pure water to generate hydrogen and oxygen for SYNGAS generation and enrichment, vii) recovery of all metals and silica like components, respectively, as metal ingots or nodules and non leaching vitrified slag, viii) conversion of scrubbed and quenched outputs into industry valuable chemicals or its recycling into to the first stage gasification process again in order to trap and neutralise undesired elements into the vitrified slag.

When compared with the prior art similar processes one can see that our presently proposed WTLH refinery achieves several improvements relatively to the conventional GTL, CTL or BTL processes. Gasification is modified to cope with any type of carbon containing feedstock (no matter if waste, biomass or fossil fuel origin) while FT products yield will increase from the conventional 6:1 up to a value between 2:1 to 1:1 (each ton of feedstock will allow the production of 0.5 to 1 ton of FT products). This means also that our newly proposed WTLH refinery will have a carbon conversion ratio close to 100% (instead of the conventional 65%). Furthermore, our WTLH refinery will be an emission-free one (no gas, liquid or solid emissions) since all feedstock constituents will come out as commercially useful products, making it a automatically compliant solution with any environment protection and preservation directives and/or conventions.

This means that with our WTLH solution, particularly via its plasma gasification stage, we will ensure the required purity for the resulting SYNGAS, thus removing all the concerns about catalyst poisoning or environment contamination.

Finally, the WTLH refinery is:
i) A method and solution to solve the modern society problem of waste processing for any type of carbon containing waste (Municipal, Industrial, Hazardous or not), without any environment emissions outside the imposed limits both by EPA (US) and European environmental laws and Directives and no further generation of any kind of secondary wastes.
ii) A method and solution that will help to solve the modern society problem of fossil fuel dependence, by reducing the need for fuel imports, reducing the dependence on limited stock fuel resources and increasing the stock safety reliability.
iii) A method and solution that will help introducing immediately synthetic diesel and gasoline at the transportation and industry market, without the need of any modification on the existing and currently used equipment.
iv) A method and solution that will help solving the summer fire problems in dry countries by creating a useful market for any type of biomass and forest residues conversion into synthetic hydrocarbons.
v) A method and solution that will help solving the instability of international market prices of fossil fuels, by creating fuel alternatives locally produced with local feedstock and with an even better technical specification than its fossil fuel counterparts.
vi) A method and solution for producing high quality synthetic hydrocarbon fuels, wherein the final synthetic diesel and naphtha species may be used directly, with no need of technical changes, in all usual appliances that currently uses fossil fuel diesel and naphtha products (like transportation appliances, but not exclusively) and whose properties perform much better than fossil fuel counterparts on what concerns the ASTM (American Society for Testing and Materials) D975 standard specification for diesel fuels, the EPA (Environment Protection Agency) requirements and the EU (European Union) EN590 standard specification for diesel fuels, namely the Waste to Liquid Hydrocarbon Refinery System diesel products have no Sulphur, no Aromatics and a cetane number almost twice the corresponding fossil fuel counterparts.
vii) A method and solution for producing high quality fuels with significantly lower environmental emissions than its fossil fuel counterparts, particularly when generated with renewable feedstock, in which case the synthetic fuels are by itself renewable.
viii) A method and solution for producing renewable synthetic hydrocarbon fuels when feedstock is of renewable origin (like biomass).
ix) A method and solution for producing renewable synthetic hydrocarbon fuels, wherein the final synthetic diesel and naphtha species yields has a significant increase when compared with the conventional methods, with, for example, about 150% yield increase for biomass and MSW feedstock.
x) A method and solution for producing renewable synthetic hydrocarbon fuels, wherein the waste reduction naturally resulting from its use in the whole system complies with recycling and waste reduction measures advised and regulated for any specifically dedicated waste processing and reduction unit.
xi) A method and solution for producing renewable synthetic hydrocarbon fuels, wherein synthetic hydrocarbons, electricity, heat and vitrified and metal sub-products are all market valuable outputs and where there are no environment emissions or residues coming out of the whole system, making it an environmentally sound and sustainable tetra-generation solution.

### 3—BRIEF DESCRIPTION OF THE DRAWINGS

The invention is now described in detail with the help of the annexed drawings, where:

FIG. 1: GTL and CTL conventional Refinery System.

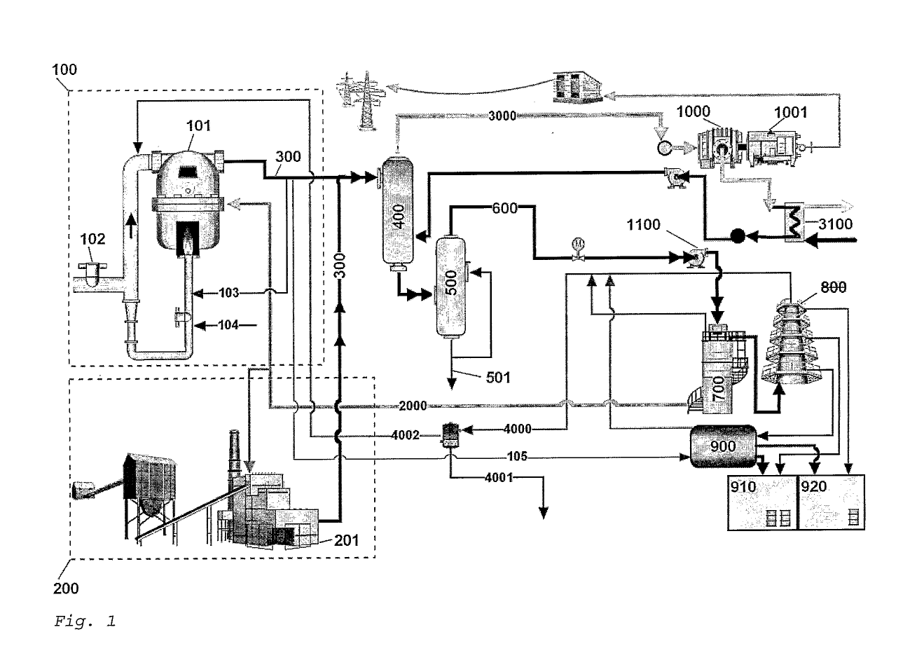

FIG. 2: Gasification subsystem for the WTLH—Waste to Liquid Hydrocarbon Refinery (base case).

FIG. 3: Hydrocarbon Synthesis subsystem for the WTLH—Waste to Liquid Hydrocarbon Refinery (base case).

FIG. 4: Electricity generation and heat co-generation subsystem for the WTLH Refinery (base case).

FIG. 5: WTLH—Waste to Liquid Hydrocarbon Refinery System base case. Any hydrocarbon family member can be generated, but particular emphasis will be on diesel and naphtha.

FIG. 6: Ensemble of subsystem options for the WTLH—Waste to Liquid Hydrocarbon Refinery System base case (base case with options).

FIG. 7: WTLH—Waste to Liquid Hydrocarbon System case with options. Any hydrocarbon family member can be generated, but particular emphasis will be on diesel and naphtha. Options can be implemented alone or ensemble. Option inclusion will result in production rate and total yield increase.

FIG. 8: WTLH—Waste to Liquid Hydrocarbon Refinery System yield simulator. For the particular feedstock composition choice (40% wood, 57% MSW, 0% Biogas, 2% old tires, 0% glycerine, 1% mineral oil, 0% coal) and no hydrogen added to the SYNGAS (and/or water added to the PETC), we see that the 500 ton per day of carbon containing feedstock (or 477.9 ton/day after slag and metal removal), will allow to produce the equivalent to 167.5 toe/day or 1222 boe/day. This simulation corresponds to Case 2- of 4-i), equations (3) and (4). Mass fluxes, in ton/day, appear inside white hexagons (input mass full line, output mass dashed line), while white arrows with numbers inside represent power fluxes in MW (thermal power over steam lines and electric power over electric lines).

FIG. 9: WTLH—Waste to Liquid Hydrocarbon Refinery System yield simulator. For the particular feedstock composition choice (40% wood, 57% MSW, 0% Biogas, 2% old tires, 0% glycerine, 1% mineral oil, 0% coal) with hydrogen added to the SYNGAS (and/or water added to the PETC), we see that the 500 ton per day of carbon containing feedstock (or 477.9 ton/day after slag and metal removal), will now allow to produce the equivalent to 290.9 toe/day or 2123.7 boe/day. This simulation corresponds to Case 3- of 4-i), equations (5) and (6). Mass and power fluxes are represented as in FIG. 8.

FIG. 10: WTLH—Waste to Liquid Hydrocarbon Refinery System yield simulator including now 2% of Biogas (some 9.3 ton/day) as the working gas of the Plasma Torch. H₂ is also added to the SYNGAS. Total FT yield increases now to 299 toe/day. Mass and power fluxes are represented as in FIG. 8.

### 4—DETAILED DESCRIPTION OF THE INVENTION

### 4.1—WTLH Base System Description

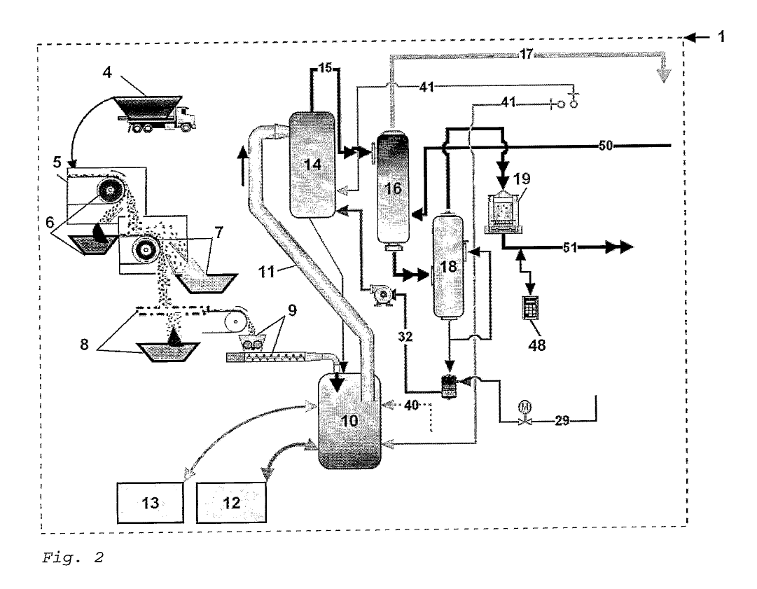

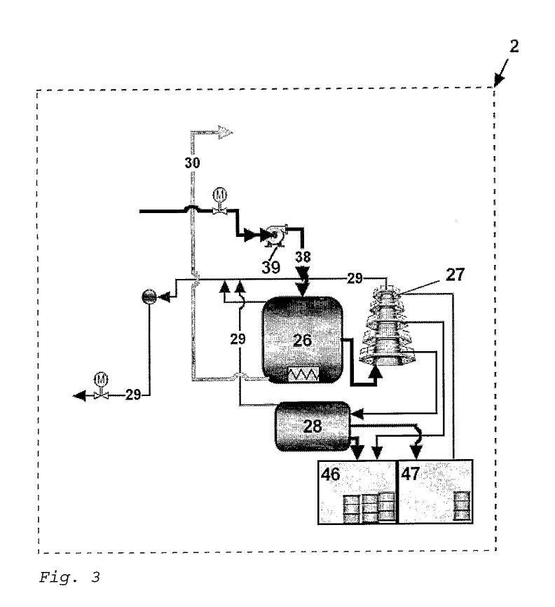

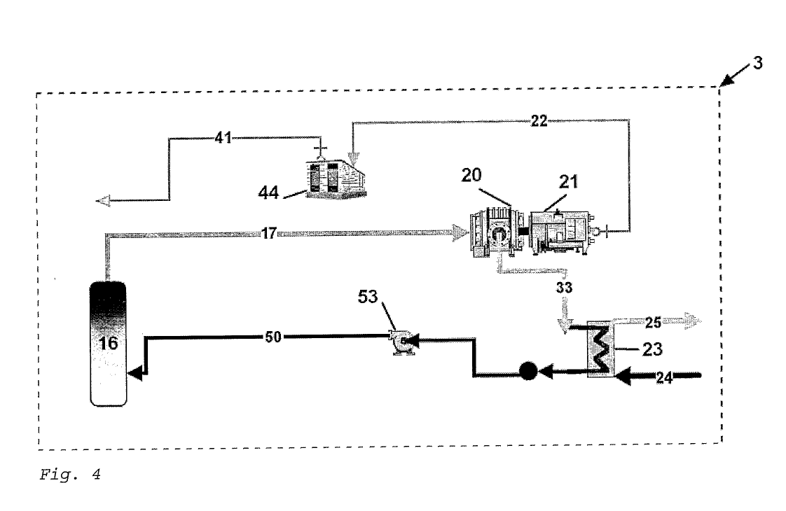

The WTLH refinery base system is composed of three major subsystems: i) the Pyro-Electric Thermal Converter (PETC) and Plasma Arc (PA) waste and biomass gasification subsystem (1) (FIG. 2), ii) the hydrocarbon synthesis subsystem (2) (FIG. 3) and iii) the electricity generation and heat co-generation subsystem (3) (FIG. 4). Each subsystem exists already alone in the market, but the ensemble combination of the three does not. The assignees have full access to authorized equipment providers. For both gasification subsystem stages and for the hydrocarbon synthesis subsystem that includes Fischer-Tropsch synthesis, hydrocarbon column distillation and hydrocracking, relevant equipment is available at authorized providers. The electricity generation and heat co-generation subsystem is based on market standard steam turbines and will be included after normal market procurement, so no particular patents need to be claimed.

### i) The Pyro-Electric Thermal Converter (PETC) and Plasma Arc (PA) Waste and Biomass Gasification Subsystem (1) for the WTLH is Composed by the Following Functional Elements (FIG. 2):

A waste and biomass feedstock reception hangar that will be maintained at negative gauge pressure, as compared to the outside atmospheric pressure, in order to avoid waste smell dispersion at the refinery surrounds.

Feedstock can be transported by several containerised means (4) (truck, train, boat, barge, etc) and then discharged on a conveyor (5) for pre-processing (FIG. 2). The first step (6) of pre-processing will consist on a magnetic separation of all ferromagnetic materials for recycling. The second step (7) will consist of an Eddy Current Separator to extract all non-iron metals from the feedstock stream. The third step (8) is a Density Separator (shaking or not) to remove all glass and silica like materials from feed stream. The sub-products resulting from these pre-processing (metals and glass like materials) will be recycled. The remaining carbon containing waste feedstock will proceed to the fourth step (9) consisting on extruding and size reduction of feed-stream materials. Also, air will be extracted from feed-stream in order to reduce its oxygen content. If the feedstock is only biomass, some of the pre-processing steps are unnecessary. For example, if the feedstock is wood, then one may proceed directly to step four (9), the Extruder Feeder, since no metals or silica like are expected to be present. For example, if the feedstock is made of forest residues, then one can start the process at step three (8), since small land field rocks and sand are expected (even if at small percentage) together with the residue biomass (mainly composed of all size branches, leaves, grass, etc).

After pre-processing the feedstock as described, the remaining material will be injected at the molten bed Pyro-Electric Thermal Converter reactor (PETC) (10) in a high temperature (1200° C. to 1500° C.) anaerobic molten iron environment where the feedstock will suffer a gasification process. The feedstock hydrogen and carbon elements will come out from the PETC reactor as a raw synthesis gas (11)—SYNGAS, mainly composed of Hydrogen (H₂) and Carbon Monoxide (CO). All other chemical elements present in the PETC feedstock stream will be retained by the molten bed (10), either at the surface floating molten slag layer (e.g. silicates, chlorine, sulphur, etc) or at the molten iron bed (e.g. all metallic elements). The floating molten slag will be automatically removed at a predefined periodicity as a non leaching vitrified slag (13) that can be used at civil construction. The metallic bed will be automatically kept at constant volume by removing metal excess and separating it into different metal ingots (12) (taking into account the different melting point temperatures for each metal species) for recycling. If required, oxygen may be injected in the PETC reactor to achieve the right stoichiometric proportion for the CO generation.

The raw SYNGAS (11) coming out from the PETC reactor (10) (mainly H₂ and CO) may still contain, although at small percentage, other undesired heavier C and H species, combined with oxygen and nitrogen. Examples of these undesired species are the tar compounds (CₓH_{y}O_{z} or CₓH_{y}N_{z}). In order to make sure that none of these eventually formed species will survive and at the same time increase the SYNGAS yield, the raw SYNGAS (11) will be further processed at a Plasmatron (14), which is the combination of a Cyclone particle/ash separator and a Plasma Arc Reactor (PR). The electrical plasma arc will completely eliminate all undesirable compounds separated at the Cyclone, by converting it to a mater plasma state (the 4^{th} state of mater, after solid, liquid and gas, where all chemical compounds will be destroyed and elements completely ionized) where temperature is everywhere above 5000° C. and only elementary ions and electrons can survive. The combined use of the PETC (10) and Plasmatron (14) reactors have the highest performance capacity available in the market today both for producing high volume and high purity SYNGAS and to completely eliminate any pollutants from the output SYNGAS stream. No fly or bottom ash, no dioxins and furans or other Persistent Organic Pollutants (POPs) can be found in our final SYNGAS stream (15). All the imposed limits on these, either by the 2001 UN Stockholm Convention on Persistent Organic Pollutants (a global treaty that obligates participating nations to minimize certain POPs, including dioxins and furans, which are known to cause cancer, suppress the immune system, and cause birth defects and identifies incineration as a major source of dioxins and furans), or by the EU—Directive 2000/76/CE of the European Parliament for the incineration case, are well accomplished in our gasification subsystem.

So, our combined PETC (10) and Plasmatron (14) waste and biomass gasification system is of high superior quality when compared with other waste processing systems, including incinerators, standard gasifiers and simple plasma reactors.

The improved SYNGAS stream (15) coming out from the Plasmatron reactor (14) will be cooled (cooling fluid (50)) at a gas thermal exchanger (16), where superheated steam (17) can be easily generated. Such superheated resulting steam (17) can be used with high efficiency on a Rankine like thermodynamical cycle of a steam turbine, to produce mechanical power.

After cooling the SYNGAS it will be further submitted to a Quencher and Scrubber cleaning process reactor (18) for further washing and removal of any still present non H₂ or CO species. All resulting wastes from this cleaning step will be reinjected at the Plasmatron (14) or at the PETC (10) for destruction and vitrification and so, again, no environment emissions will be produced. A final cleaning and SYNGAS purification step is made at the Active C ZnO filtering system (19). By this we will make sure that the final SYNGAS (51) will comply with the required purity for environment and catalyst protection in our WTLH refinery Hydrocarbon Synthesis subsystem. This is permanently monitored at the SYNGAS Analyser (48).

The WTLH gasification subsystem (1) requires electricity both for the PETC (10) and Plasmatron (14) reactors. The required SYNGAS cooling process (16) will be enough to feed a Rankine cycle (FIG. 4) with a steam turbine component (20) coupled to an electricity generator (21). The auto-generated electricity (22) will be further transformed at (44) into adequate electric current (41), which is enough to keep the exothermic PETC (10) and Plasmatron (14) normal running and at the same time have an excess of electricity that may be sold to the grid (FIG. 4). Such an electricity generation and feeding system makes up the electricity generation and heat co-generation subsystem (FIG. 4).

Several technical and environmental benefits of treating waste and biomass by our Pyro-Electric Thermal Converter (PETC) (10) and Plasma Arc (PA) (14) gasification subsystem can be identified.

The objective of pure combustion is reacting the carbon containing feedstock with oxygen. Such chemical reaction will generate CO₂, water vapour and release heat. The objective of a gasification process is to convert the carbon and hydrogen in the waste to a fuel gas composed of CO and H₂ and not to combust any of the waste. The gasification chemical reaction needs an oxygen starved environment to happen. The oxygen required for gasification (40) is less than 30% of the oxygen required for combustion.

The fuel gas generated by gasification, called SYNGAS, still contains most of the chemical and heat energy of the waste. Achieving pure gasification will require an external heat source. In general, gasifiers use partial combustion in order to generate the heat required for gasification. However, this causes both the formation of tars and dioxins in the fuel gas and the loss of energy, that is, an inferior fuel gas that is high in CO2 and various contaminants. With our proposed Pyro-Electric Thermal Converter (PETC) (10) and Plasma Arc (14) (PA) gasification subsystem only a maximum of 5% of carbon will be converted to CO₂, which compares with the 35% to 55% of normal gasifiers and with the 95% of modern incinerators. This is so because we will be able to achieve much higher temperatures than those of normal gasifiers. The electricity required to operate our gasification subsystem will be obtained via the integrated electricity generation and heat co-generation subsystem that will be described below and no further loss of carbon will be required.

At these higher temperatures of our Plasma Arc reactor (14) all tars, chars and dioxins will simply not form or, if so, they will be fully destroyed at the Plasma Arc reactor (14) component. This is a very important environment benefit achievable with our subsystem. In fact, the breakdown of organic matter produces tars, which are composed of various molecules of carbon, hydrogen and oxygen or nitrogen (CₓH_{y}O_{z} or CₓH_{y}N_{z} compounds). Common tar examples are furans (Furfuran C₄H₄O, 2-Methylfuran C₅H₆O, Furanone C₄H₄O₂), phenols (Phenol C₆H₆O, Cresol C₇H₈O), aldehydes (Formaldehyde CH₂O, Acetaldehyde C₂H₄O), ketones (2-Butenone C₄H₆O, Cyclohexanone C₆H₁₀O) and nitrogen containing tars like 1H-Pyrrole (C₄H₅N), Pyridine (C₅H₅N), Methylpyridine (C₆H₇N), Benzo-quinoline (C₁₃H₉N), etc. These tar compounds will condense inside the reactor if its temperature is not high enough (lower than 1000° C.) and further contaminate chars (that is, carbon that has not been converted to CO). In normal gasifiers and in modern incinerators the tars condense out and attach to the char. The contaminated char becomes part of the bottom ash rendering it toxic. The breakdown of plastics, chlorinated solvents and other chlorinated chemicals at temperatures lower than 1000° C. will also produce dioxins. However, at temperatures higher than 1100° C. no chars, tars and dioxins will form, rendering it an easy task for our Plasma Arc reactor (14) where temperatures above 5000° C. make rule. In summary, our proposed Pyro-Electric Thermal Converter (PETC) (10) and Plasma Arc (PA) (14) gasification subsystem (1) breaks down all the tars, leaves no char, produces no toxic ash, leaves no dioxins, maximizes the clean SYNGAS production, minimizes the loss of carbon and together with our integrated electricity generation and heat co-generation subsystem (2) (to be described below) will be energy auto-sufficient.

### ii) The Hydrocarbon Synthesis Subsystem (2) for The WTLH is Composed by the Following Functional Elements (FIG. 3):

The clean SYNGAS (51) coming out from the previously described gasification subsystem (1) will now constitute the feedstock of our WTLH refinery hydrocarbon synthesis subsystem (2). The first step in this subsystem is to compress the SYNGAS at (39) and deliver it (38) at the right pressure to the Fischer-Tropsch (FT) synthesis reactor (26), where the SYNGAS will give place to hydrocarbon compounds and water and/or CO₂, via chemical reactions catalysed by iron/cobalt dominated catalysts. When aiming for long-chain products, pressures of around 25-60 bars and temperatures around 200-250° C. are used at the FT reactor (26). FT hydrocarbon synthesis demands a high level of SYNGAS purity (e.g. H₂S+COS+CS₂<1 ppmv; NH₃+HCN<1 ppmv; HCl+HBr+HF<10 ppbv; alkali metals (Na+K)<10 ppbv; particles (soot, ash) “almost completely removed”; hetero-organic components (incl. S, N, O)<1 ppmv). This can easily be achieved by our previously described SYNGAS Gasification and cleaning subsystem (FIG. 2). The present synthesis hydrocarbon subsystem component is the result of putting together equipment available at authorized providers and will be implemented in this WTLH refinery. In a second step, the hydrocarbon products coming out from the FT reactor will be subjected to standard refinery fractional distillation (27) in order to isolate the targeted hydrocarbons, like diesel (46) and gasoline (47) (from naphtha group). The heavier wax products will be further submitted to a Hydrocracking process (28) where the heavier hydrocarbons will be split off into the diesel and gasoline lighter products. Hydrocracking is a standard technique used in the petrochemical industry to recycle refinery wastes. Hydrocracking demands extra hydrogen that usually comes from a SYNGAS side-stream that is completely shifted to hydrogen via the WGS (Water Gas Shift) reaction. Distillation (27) and hydrocracking (28) steps will be supported also by in the market equipment available at authorized providers. Un-reacted SYNGAS or undesired products coming out from these subsystem units, jointly called as Tail Gas (29), will be re-injected at the Plasma Arc reactor (14) of our gasification subsystem (1), in order to convert them again into clean SYNGAS for further use as synthetic hydrocarbon feedstock. The exothermal FT synthesis will further generate abundant steam (30) that can be added and used together with the already formed gasification steam.

iii) The Electricity Generation and Heat Co-Generation Subsystem (3) for the WTLH is Composed by The Following Functional Elements (FIG. 4):

The total steam resulting from adding up steam formed at the SYNGAS cooling process (17) of our WTLH refinery gasification subsystem (1) with steam (30) formed at our WTLH refinery hydrocarbon synthesis subsystem (2), will feed the steam turbine (20) of a Rankine like thermodynamical cycle to produce mechanical energy and low enthalpy. Depending on pressure and temperature of superheated steam from both SYNGAS cooling (16) and FT (26) reactor, each may be injected either in the High Pressure or in the Low Pressure section of the Steam Turbine. Such mechanical energy will be further converted at the electrical generator (21) into electricity (22) that will be used to feed all electric needs (41) of the whole WTLH refinery, after transforming it at (44) and its excess can further be sold to the electrical grid. The final low enthalpy resulting from the condenser (23) component of the thermodynamical cycle will be further co-generated and used at the pre-processing stage of organic feedstock in subsystem one, in order to lower down its water content. The Rankine cycle is complemented with a condenser (23), which receives low pressure steam (33) coming from the turbine (20) and provides water (50), which is resent to the gas thermal exchanger (16), after compression at (53). This condenser (23) receives cold water (24) for condensation and provides hot water (25) that can be used for suitable purposes.

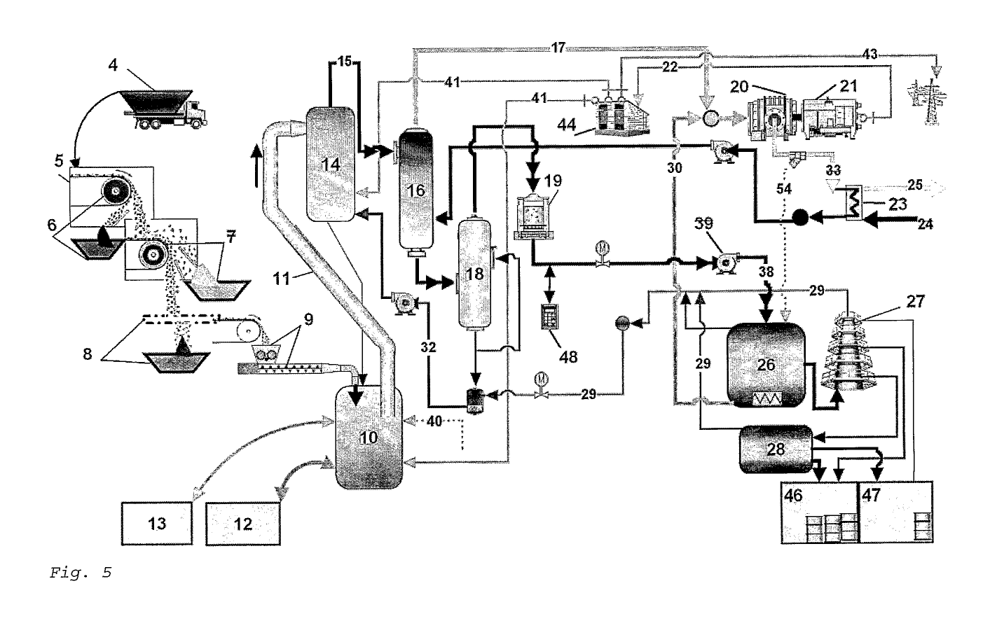

Putting together all the previously described subsystems, the complete WTLH refinery base system is formed and is presented at FIG. 5.

Any hydrocarbon family member can be generated, but particular emphasis will be on diesel and naphtha. The full base case WTLH—Waste to Liquid Hydrocarbon Refinery system is composed by integrating together all the components described in FIG. 2, FIG. 3 and FIG. 4. The connection between the three subsystem components is made by: i) purified SYNGAS coming out from the gasification sub-system is compressed and delivered to the FT reactor, ii) steam coming out from FT reactor and from SYNGAS cooling is delivered to the steam turbine for electricity generation, iii) local generated electricity is delivered to the PETC and Plasmatron reactors (as well as to other low consumption electrical appliances), while the excess is sold to the utility grid, iv) tail gas from the different hydrocarbon synthesis units is recycled back into the Plasmatron (although it can also be to the PETC or to the SYNGAS stream).

### 4.2—Modifications or Alternatives to the Base System

### Case with Optimization Options

The previously described WTLH—Waste to Liquid Hydrocarbon Refinery System base case can be modified and upgraded with several options that will either further improve its overall yield of final synthetic hydrocarbon products and/or introduce new products in the flow stream. The spread in carbon number products can be varied by changing the feedstock composition, the operating temperature, the operating pressure, the catalyst composition and the type and amount of promoter, the feed SYNGAS composition, the type of equipment (either for FT reaction or for Hydrocracking) and the optimization of the different energy cycles of the whole refinery. The options to be described will directly or indirectly affect the final hydrocarbon production ratio. These innovative options are claimed to be part of the same presently proposed WTLH Refinery System.

Options to include in this WTLH Refinery System will fall into the following categories:
i) Use of H2RE (Renewable Hydrogen) locally produced or from external source directly into the FT reactor (26) or as an a priori SYNGAS enrichment.
ii) Use of H2RE locally produced or from external source at the hydrocracking phase (28).
iii) Use of waste mix feedstock including HIW (hazardous industrial wastes) at the PETC (10). This waste mix may also include the use of coal as any Coal to Liquid system does and/or the use of Biogas.
iv) Use of Biogas (31) as Plasma Torch Gas (32) or inside the Plasma Reactor (PR) (14).
v) Use of Hydrocarbon Synthesis Tail Gas (29) as Plasma Torch Gas (32) or inside the PR.
vi) Use of Quencher and Scrubber residues as Plasma Torch (32) working fluid or inside the PR (14).
vii) Use superheated steam either from FT reactor (30) or from SYNGAS cooling (17) to feed a Steam Turbine (20) either at its high or low pressure section.
viii) Use electricity generated at the local steam turbine subsystem (3) to feed all local refinery needs, including local generation of hydrogen.
ix) Use stoichiometric water injection at the PETC level, instead of O₂, both to deliver oxygen for CO formation (as O₂ injection does) and increase the hydrogen content in the final SYNGAS.
x) Use excess water purged from the steam turbine cycle to inject it in the PETC (10) and/or electrolyse it and generate H₂ (for i) and ii) and O₂ to use locally at the PETC (10).
xi) Use low enthalpy energy input from environment and local co-generation systems to produce hydrogen locally.
xii) Tailoring the FT reactor (26), the distillation column (27) and the hydrocracking reactor (28) for variable % generation of FT-diesel and FT-gasoline.

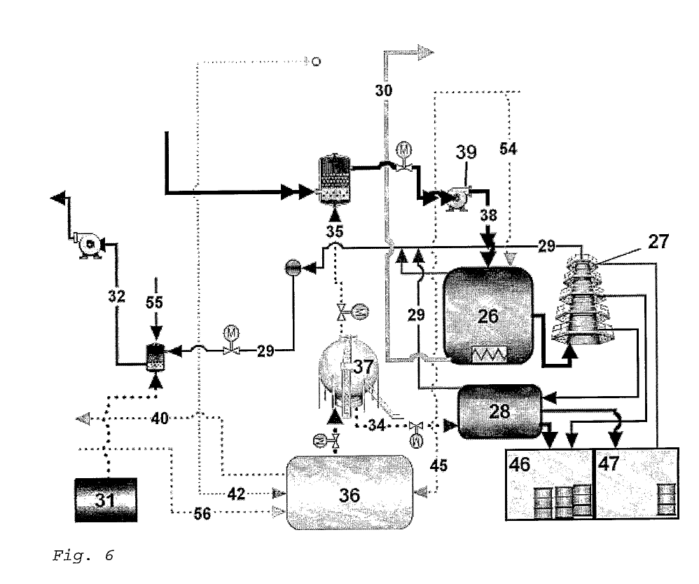

The ensemble of these WTLH refinery option categories is shown in FIG. 6.

### i) Use of H2RE Locally Produced or from External Source (36) and Stored at (37), Directly into the FT Reactor (26) or as an a Priori SYNGAS Enrichment (35)

It is very important that the conversion of SYNGAS to hydrocarbon products in the FT reactor (26) is as efficient as possible, i.e. that as much as possible of the reactants (CO and H₂) are consumed to provide useful hydrocarbons. Directly generated feedstock SYNGAS has a proportion of Hydrogen relative to CO which is smaller than required by hydrocarbon synthesis. With the Alkanes synthesis reaction given by: nCO+(2n+1)H₂→CₙH₍₂ₙ₊₂₎+nH₂O, the theoretical usage ratio of desired FT Alkanes is (2n+1)/n. For example, for the diesel family member C₁₂H₂₆ the usage ratio is 2.083. Similarly, for the Alkenes we have: nCO+2nH₂→CₙH₂ₙ+nH₂O and the theoretical usage ratio of desired FT Alkenes is now 2. Table 1 summarises a few examples of feedstock composition and its theoretical SYNGAS yield and H₂ to CO ratio. As it can be seen in table 1 (rightmost column) the gasification of original feedstock (represented by the equation: z(Cᵣ_{₁}Hᵣ_{₂}Oᵣ_{₃})+xO₂→sₛCO+yₛH₂, where r₁, r₂, r₃ are, respectively, the proportions of C, H and O at the input feedstock) will produce a H₂ to CO ratio (yₛ/sₛ) for the different feedstock types that is below the ideal usage ratio. In order to bring the original SYNGAS ratio close to the ideal usage ratio we can either lower the CO content by forming CO₂ and H₂ and consuming CO and formed H₂O at the hydrocarbon synthesis reaction or increase the H₂ content by injecting it (35) into the original SYNGAS. These two options may be achieved in a number of different ways and all these will be claimed to be part of our WTLH Refinery System.

TABLE 1
Examples of feedstock stoichiometric composition to be used in the WTLH—Waste to
Liquid Hydrocarbon Refinery System and corresponding SYNGAS proportion yield according
with the SYNGAS generation equation: z (Cᵣ_{₁}Hᵣ_{₂}Oᵣ_{₃}) + xO_{2 → ss} CO + yₛ H₂.

| Substance (proportion) | C (r1) | H (r2) | O (r3) | slag | metals | Z | X | Ys | Ss | R = H2/CO |
|---|---|---|---|---|---|---|---|---|---|---|
| Dry Wood (Biomass) | 1.00 | 1.50 | 0.70 | 1.00% | 1.00% | 1.00 | 0.15 | 0.75 | 1.00 | 0.75 |
| MSW | 1.00 | 1.60 | 0.60 | 2.00% | 4.00% | 1.00 | 0.20 | 0.80 | 1.00 | 0.80 |
| Biogas | 1.00 | 3.92 | 0.04 | 1.00% | 1.00% | 1.00 | 0.48 | 1.96 | 1.00 | 1.96 |
| Old Tires | 1.00 | 1.01 | 0.02 | 3.00% | 5.00% | 1.00 | 0.49 | 0.50 | 1.00 | 0.50 |
| Glycerine | 1.00 | 2.67 | 1.00 | 1.00% | 1.00% | 1.00 | 0.00 | 1.33 | 1.00 | 1.33 |
| Mineral Oil | 1.00 | 2.08 | 0.00 | 3.00% | 1.00% | 1.00 | 0.50 | 1.04 | 1.00 | 1.04 |
| (mean: C25 H52) | | | | | | | | | | |
| Coal | 1.00 | 0.71 | 0.07 | 5.00% | 1.00% | 1.00 | 0.47 | 0.36 | 1.00 | 0.36 |
| | | | | mass % | mass % | | | | | |

Three general cases may be considered to bring original SYNGAS ratio close to the ideal usage ratio:

### Case 1—Only the Original Feedstock SYNGAS is Given as Input to the FT Reactor (26):

Lowering the relative CO content is the conventional way to proceed. The reduction of CO follows the standard Water Gas Shift reaction (WGS) CO+H₂O [symbol] CO₂+H₂ and will operate together with the hydrocarbon (Alkanes, Alkenes, etc) synthesis reaction. At equilibrium the rate of consumption of CO+H₂ is independent of the extent of the WGS reaction, since CO and H₂ are on opposite sides of the WGS equation, but the amount of Alkanes and Alkenes produced is dependent of the amount of H₂ present in the SYNGAS. In such case, the expected hydrocarbon yield, represented by the C₁₂H₂₆ yield (p₁=12 and p₂=26), is governed by the equation:

$${s}_{s} CO + {y}_{s} {H}_{2} -> {zC}_{{p}_{1}} {H}_{{p}_{2}} + {{x H}_{2} O + r CO}_{{WGS ↕}_{{w CO}_{2} + {t H}_{2}}} \qquad ( 1 )$$

Where sₛ and yₛ are fixed values given by the specific original feedstock SYNGAS (see table 1). With sₛ and yₛ given, (z,x,r) may by calculated as follows:

$$( z = \frac{2 {y}_{s}}{( {p}_{2} + 2 {p}_{1} )} , x = {p}_{1} z , r = {s}_{s} - x ) \qquad ( 2 )$$

As soon as water starts to form at the FT reactor (26), iron catalysts will promote also WGS and an equilibrium situation between WGS reactants H₂O and CO and WGS products CO₂ and H₂ will be established. If no water is feed in the FT reactor, WGS can start only after hydrocarbon synthesis start itself. All CO and H₂ will be consumed, but only part of it, the right stoichiometric proportion will produce synthetic hydrocarbon. For this conventional case 1-, the resulting C₁₂H₂₆ yield is summarised in Table 2 for the different feedstock considered. For example, for dry wood feedstock in this case 1-, a maximum yield of 206 kg of C₁₂H₂₆ per ton of feedstock is expected.

TABLE 2
Case 1- summary of hydrocarbon FT product yield (C₁₂H₂₆) as a function of original
feedstock SYNGAS in our WTLH—Waste to Liquid Hydrocarbon Refinery System.

| | | | | | | Normalised mass balance value | | | | | | | |
|---|---|---|---|---|---|---|---|---|---|---|---|---|---|
| | | | | | | (ton of product/ton feedstock) | | | | | | | |
| | | | | | | | | | | Lost CO | | | |
| Feedstock | Ss | Ys | Z | X | R | CO | H2 | FT-Diesel | H2O | non-diesel | CO2 | H2 | Tail Gas |
| Dry Wood | 1.000 | 0.750 | 0.030 | 0.360 | 0.640 | 1.134 | 0.061 | 0.206 | 0.262 | 0.726 | 0.64129555 | 0.02915 | CO |
| MSW | 1.000 | 0.800 | 0.032 | 0.384 | 0.616 | 1.207 | 0.069 | 0.234 | 0.298 | 0.743 | 0.72827586 | 0.033103 | CO |
| Biogas | 1.000 | 1.960 | 0.078 | 0.941 | 0.059 | 1.691 | 0.237 | 0.805 | 1.023 | 0.100 | 0.15729469 | 0.00715 | H2O |
| Old Tires | 1.000 | 0.504 | 0.020 | 0.242 | 0.758 | 2.101 | 0.076 | 0.257 | 0.326 | 1.593 | 0.79792301 | 0.036269 | CO |
| Glycerine | 1.000 | 1.333 | 0.053 | 0.640 | 0.360 | 0.913 | 0.087 | 0.296 | 0.376 | 0.329 | 0.51652174 | 0.0023478 | H2O |
| Mineral Oil | 1.000 | 1.040 | 0.042 | 0.499 | 0.501 | 1.989 | 0.148 | 0.502 | 0.638 | 0.996 | 1.56 | 0.070909 | CO |
| (mean: C25 H52) | | | | | | | | | | | | | |
| Coal | 1.000 | 0.356 | 0.014 | 0.171 | 0.829 | 2.032 | 0.052 | 0.175 | 0.223 | 1.685 | 0.5449304 | 0.02477 | CO |

(WGS equilibrium <=> non diesel production)
Values on green are feedstock normalised mass balances. First 5 numerical columns represent stoichiometric coefficients of equation (1); columns 6 and 7 the SYNGAS input proportion in ton/ton of feedstock; columns 8, 9 and 10, respectively, C₁₂H₂₆, H₂O and lost CO (to FT product generation) from right hand side equation (1) in ton/ton of feedstock; Columns 11 and 12 the WGS equilibrium and the last column the dominant Tail Gas species (other than C₄ and smaller compounds, like CH₄).

Case 2—Together with the Original Feedstock SYNGAS, Steam is Injected as an Input Reactant to the FT Reactor:

In order to reduce the C lost in the synthesis of hydrocarbon at the FT reactor (26), Case 1- can be modified by adding external steam coming, for example, from the Steam Turbine (20) at subsystem 3. With an increase in the H₂O content at the FT reactor, Le Chatelier principle will create an equilibrium bias at the WGS reaction towards the formation of more H₂, increasing thus the H₂ to CO ratio and minimising further losses of SYNGAS CO. Again, at WGS equilibrium the rate of consumption of CO+H₂ is independent of the extent of the WGS reaction, since CO and H₂ are on opposite sides of the WGS equation, but since more H₂ than what comes in via the original SYNGAS is now available, the amount of Alkanes and Alkenes that can be generated is now also greater than in Case 1-. In such case, the expected hydrocarbon yield, represented by the C₁₂H₂₆ yield, is governed by the equation:

$${s}_{s} CO + ( {y}_{s} + ds ) {H}_{2} + {ds H}_{2} O -> {zC}_{{p}_{1}} {H}_{{p}_{2}} + {x H}_{2} O + {{ds CO}_{2} + {ds H}_{2}}_{{WGS ↕}_{{ds H}_{2} O + ds CO}} \qquad ( 3 )$$

Where sₛ and yₛ are fixed values given by the specific original feedstock SYNGAS (see table 1). With sₛ (C proportion in feedstock) and yₛ (H₂ proportion in feedstock) given, (z, x, ds) may be calculated as follows:

$$( z = \frac{{s}_{s} - ds}{{p}_{1}} , x = {p}_{1} z , , ds = \frac{{s}_{s} {p}_{2} + 2 ( {s}_{s} - {y}_{s} ) {p}_{1}}{{p}_{2} + 4 {p}_{1}} ) \qquad ( 4 )$$

For this innovative Case 2- in the presently proposed WTLH Refinery System, the resulting C₁₂H₂₆ yield is greater than in Case 1- and is summarised in Table 3 for the different feedstock considered. For example, for dry wood feedstock in this case 2-, a maximum yield of 326 kg of C₁₂H₂₆ per ton of feedstock is expected, which contrasts with the previous Case 1- yield of 206 kg, that is, from Case 1- to 2- we may have a C₁₂H₂₆ yield gain of 58%.

TABLE 3
Case 2- summary of hydrocarbon FT product yield
(C₁₂H₂₆) as a function of original feedstock SYNGAS
in our WTLH —Waste to Liquid Hydrocarbon Refinery System.

| | Feed H2O | Final | Final | Final |
|---|---|---|---|---|
| Feedstock | to WGS | FT-diesel | H2O | CO2 |
| Dry Wood | 0.315 | 0.326 | 0.414 | 0.770 |
| MSW | 0.323 | 0.356 | 0.453 | 0.789 |
| Biogas | 0.043 | 0.821 | 1.043 | 0.106 |
| Old Tires | 0.692 | 0.518 | 0.659 | 1.692 |
| Glycerine | 0.143 | 0.350 | 0.444 | 0.349 |
| Mineral Oil (mean: C25 H52) | 0.433 | 0.666 | 0.846 | 1.057 |
| Coal | 0.732 | 0.452 | 0.574 | 1.790 |

Values on green are feedstock normalised mass balances. First numerical column is external H₂O injected into the WGS reaction in ton/ton of feedstock; columns 2, 3 and 4 are, respectively, C₁₂H₂₆, output H₂O and CO₂ in ton/ton of feedstock.

Case 3—Together with the Original Feedstock SYNGAS, Hydrogen (Renewable or not) is Injected as an Input Reactant to the FT Reactor (26):

In order to minimise the C lost in the synthesis of hydrocarbon at the FT reactor (26), Cases 1- and 2- can be replaced by a Case 3- where external H₂ (36), preferably of renewable origin (either locally produced, with water (45) and electricity (42) and heat (56), or not), stored at (37), is added (35) to the original SYNGAS, increasing thus the H₂ to CO ratio and minimising further losses of SYNGAS CO. In this case WGS will not have favourable conditions to proceed and theoretically no losses of C will happen. The amount of Alkanes and Alkenes that can be generated is now also greater than in Cases 1- and 2-. In such case, the expected hydrocarbon yield, represented by the C₁₂H₂₆ yield, is governed by the equation:

s₂CO+y_{new}H₂→zCₚ_{₁}Hₚ_{₂}+xH₂O (5)

Where sₛ it is the fixed value given by the specific original feedstock SYNGAS (see table 1). With sₛ given (C proportion in feedstock), the z, x) values may be calculated as follows:

$$( {y}_{new} = \frac{{s}_{s} ( {p}_{2} / {p}_{1} + 2 )}{2} , z = {s}_{s} / {p}_{1} , x = {p}_{1} z ) \qquad ( 6 )$$

According with equation (6) the hydrogen that must be added is y_{injected}=y_{new}−yₛ where yₛ is the original SYNGAS proportion of H₂ (see table 1). For this innovative Case 3- in the presently proposed WTLH Refinery System, the resulting C₁₂H₂₆ yield is greater than in both Cases 1- and 2- and is summarised in Table 4 for the different feedstock considered. For example, for dry wood feedstock in this case 3-, a maximum yield of 574 kg of C₁₂H₂₆ per ton of feedstock is expected, which contrasts with the previous Case 1- yield of 206 kg and the Case 2- yield of 326 kg, that is, from Case 2- to 3- we may have a C₁₂H₂₆ yield gain of 76% and from Case 1- to 3- we may have a C₁₂H₂₆ yield gain of 178%. This compares, for example, with more conventional expected yields of 210 l (or 165 kg) per ton of wood feedstock (ECN in 2003) and of 216 kg of FT diesel per ton of coal (Rentech Inc in 2005).

TABLE 4
Case 3- summary of hydrocarbon FT product yield (C₁₂H₂₆) as a function
of original feedstock SYNGAS in our WTLH Refinery System.

| | Feedstock | Final | Final | Final | Injected |
|---|---|---|---|---|---|
| Feedstock | Cr1Hr2Or3 | FT-diesel | H2O | SYNGAS | H2RE |
| Dry Wood | 1.000 | 0.574 | 0.729 | 1.302 | 0.108 |
| MSW | 1.000 | 0.611 | 0.776 | 1.386 | 0.111 |
| Biogas | 1.000 | 0.855 | 1.087 | 1.942 | 0.015 |
| Old Tires | 1.000 | 1.063 | 1.351 | 2.414 | 0.237 |
| Glycerine | 1.000 | 0.462 | 0.587 | 1.049 | 0.049 |
| Mineral Oil (mean: C25 H52) | 1.000 | 1.006 | 1.278 | 2.285 | 0.148 |
| Coal | 1.000 | 1.028 | 1.306 | 2.335 | 0.251 |

Values on green are feedstock normalised mass balances. First numerical column is reference feedstock; column 5 is external H₂ injected into the SYNGAS, columns 2 and 3 are, respectively, C₁₂H₂₆ and output H₂O and column 4 the final mass of SYNGAS, after adding new H₂, all in ton/ton of feedstock.

It is claimed as innovative the injection of H₂ into the WTLH Refinery System, in order to increase the overall content of hydrogen in the SYNGAS. Renewable Hydrogen (H₂RE) is the preferred input. Table 5 summarises and compares C₁₂H₂₆ yield for all the three presented cases.

TABLE 5
Comparison of hydrocarbon FT product yield (C₁₂H₂₆) in ton/ton feedstock for the three
WTLH—Waste to Liquid Hydrocarbon Refinery System options analysed (green columns).

| | Case 1 | | Case 2 | | Case 3 | | Case 2/1 | Case 3/1 | Case 3/2 |
|---|---|---|---|---|---|---|---|---|---|
| | Final | Final | Final | Final | Final | Final | % Gain in | % Gain in | % Gain in |
| Feedstock | FT-diesel | H2O | FT-diesel | H2O | FT-diesel | H2O | FT-diesel | FT-diesel | FT-diesel |
| Dry Wood | 0.206 | 0.262 | 0.326 | 0.414 | 0.574 | 0.729 | 57.7% | 177.8% | 76.2% |
| MSW | 0.234 | 0.298 | 0.356 | 0.453 | 0.611 | 0.776 | 52.0% | 160.4% | 71.3% |
| Biogas | 0.805 | 1.023 | 0.821 | 1.043 | 0.855 | 1.087 | 2.0% | 6.3% | 4.2% |
| Old Tires | 0.257 | 0.326 | 0.518 | 0.659 | 1.063 | 1.351 | 101.8% | 313.8% | 105.1% |
| Glycerine | 0.296 | 0.376 | 0.350 | 0.444 | 0.462 | 0.587 | 18.2% | 56.3% | 32.1% |
| Mineral Oil | 0.502 | 0.638 | 0.666 | 0.846 | 1.006 | 1.278 | 32.5% | 100.3% | 51.1% |
| (mean: C25 H52) | | | | | | | | | |
| Coal | 0.175 | 0.223 | 0.452 | 0.574 | 1.028 | 1.306 | 157.6% | 486.0% | 127.5% |

Blue columns represent the percentage gain in FT-diesel yield compared with Case 1- (first two blue columns) from case 3- relative to case 2-. Final water yield for each case is also shown in ton of water/ton of feedstock.

Case 2- represents already a significant gain in FT product yield. In particular, for the tires and coal feedstock the gains are superior to 100% and 150% respectively. A further upgrade from case 2- to case 3- will represent again a significant gain. The final gain from case 1- to 3- is particularly high in the biomass and Municipal Solid Waste (MSW) cases, respectively, 178% and 160% and in the HIW tires and Mineral Oil cases (314% and 100%, respectively). The gain record is, however, between cases 3 and 1 for coal feedstock with a performance yield gain of up to 486%.

### ii) Use of H2RE Locally Produced or From External Source at the Hydrocracking Phase (28)

Alternatively or in parallel with the use of hydrogen in the FT reactor (26), as described in 4-i), hydrogen may also be used (34) in the Hydrocracking reactor (28), where the heavy hydrocarbon products leaving the bottom of the Distillation Column (27), mainly of the Wax family, will be broken into lighter products, with particular emphasis on the generation of diesel and naphtha families. Input Hydrogen will be used to complete the right stoichiometric proportion of the newly resulting products (hydrogenation). Using the Wax to Diesel example described by the equation C₃₆H₂₄+2H₂→3C₁₂H₂₆, it can be seen that 7.9 kg of H₂ are required to crack 1 ton of C₃₆H₇₄ and obtain 1007.9 kg of C₁₂H₂₆.

### iii) Use Of Waste Mix Feedstock Including HIW (Hazardous Industrial Wastes) at the PETC (10). This Waste Mix May Also Include the Use of Coal as any Coal to Liquid System does and/or the Use Biogas

As previously mentioned, our gasification sub-system (1) is able to deal with any kind of biomass and/or with any kind of waste, either from the MSW (Municipal Solid Waste) or from the HIW (Hazardous Industrial Waste) types, without any kind of emissions into the environment. If no matter the feedstock type, it has the particularity of being a carbon containing one, then this unique gasification sub-system combined with the synthetic hydrocarbon sub-system, makes it possible for the first time to produce synthetic hydrocarbon products (particularly diesel and naphtha families) from any kind of carbon containing waste and/or biomass.

### iv) Use of Biogas as Plasma Torch Gas (32) or Inside the Plasma Reactor (PR) (14)

Biogas is a gas whose composition is dominated by methane (up to 75% of CH₄, 5% CO₂, 15% N₂ and 5% of other gases). It may be produced from animal dung, sewage or manure in a purpose-built slurry digester with up to 95% water. Biogas it is produced by methanogenic bacterial activity in an anaerobic environment at temperatures ranging from 35° C. to 50° C. The resulting gas may be further purified to increase its concentration on methane up to close 99% and for sulphur removal.

Injecting purified Biogas into the gasification stream, even at small percentage, will significantly increase the hydrogen to CO ratio, improving the overall ratio of the final SYNGAS, bringing it closer to the H₂ to CO usage ratio at the FT reactor as previous mentioned. Injection of Biogas into the gasification stream will thus reduce the need for extra hydrogen. Enriched Biogas may be introduced either at the PETC (10) level or as the working gas of the Plasma Torch (32) at the PR (14). In any case, it will be gasified into SYNGAS and integrated in the general SYNGAS stream (15). An advantage of introducing it at the Plasma Torch (32) is that it will add to the final SYNGAS, without changing the PETC capacity, while any impurity still present (like residual sulphur) will be easily dissociated by the plasma and removed at the Quencher & Scrubber reactor (18). Typically an x % increase on mass feedstock, via the enriched Biogas injection at the Plasma Torch (32), will cause a final synthetic hydrocarbon overall yield mass increase of about x % too.

### v) Use of Hydrocarbon Synthesis Tail Gas (29) as Plasma Torch Gas (32) or Inside the PR (14)

Similarly to the previously described injection of Biogas into the gasification stream, Tail Gas (29) (unreacted gas or non-desired newly formed gas) coming out either from the FT reactor (26) or from the Distillation Column (27) or from the Hydrocracking reactor (28) will be recycled into the SYNGAS production phase. Tail Gas (29) may well be introduced as Plasma Torch gas (32), as PR feedstock or at the level of the PETC (10) (as system feedstock). Recycling Tail Gas (29) is a common practice in other FT systems as it results in higher overall conversion of the fresh feed. Besides that, such procedure helps both with heat removal, particularly in fixed bed reactors and with the need to remove water and avoid excessively high water partial pressure, that otherwise will limit the per pass conversion ratio. However, injecting the Tail Gas (29) at the Plasma Torch (32) as the working gas is innovative and has never been done before. This procedure will cope both with the need of preserving feedstock C and H components and with the need to preserve the absence of any type of environment emissions.

### vi) Use of Quencher and Scrubber Residues as Plasma Torch (32) Working Fluid or Inside the PR (14)

Similarly to the previously described injection of Biogas (31) and Tail Gas (29) into the gasification stream, Quencher and Scrubber residues (mainly at liquid phase) coming out from the final cleaning step of SYNGAS may either be recycled into the SYNGAS production phase or periodically removed as commercially valuable products. If it is recycled into the SYNGAS production phase, it can be introduced either as Plasma Torch (32) working fluid, as PR feedstock or at the level of the PETC (as system feedstock). Again, this procedure will cope both with the need of preserving feedstock C and H components and with the need to preserve the absence of any type of environment emissions.

### vii) Use Superheated Steam (30, 17) Either From FT Reactor (26) or From SYNGAS Cooling (16) to Feed a Steam Turbine (20) Either at its High or Low Pressure Section

The cooling process of SYNGAS and the exothermic reaction of hydrocarbon synthesis will allow the production of steam. The FT hydrocarbon synthesis process is able to produce an amount of steam weight that is given in table 5 in ton of water/ton of feedstock and for the three production cases described above. Generated Steam can be used together in the Steam Turbine, taking into account its different enthalpy contents and injecting it at the most suitable section of the turbine (either in its low pressure or in its high pressure section).

It can be shown that the steam formed during FT reaction with SYNGAS enriched with hydrogen can be a superheated one, suitable for steam turbine use. In fact, the FT diesel equation with H₂RE may be written as:

sₛCO+y_{new}H₂□zCₚ_{₁}Hₚ_{₂}+xH₂O

With T=250° C. and for the reaction in equilibrium conditions we get:

$$\{ \begin{matrix}Δ {G}^{0} = - RT log {K}_{p} ⇔ {K}_{p} = {e}^{- \frac{Δ {G}^{0}}{RT}} \\ {K}_{p} = \frac{{P}_{{C}_{{p}_{1}} {H}_{{P}_{2}}}^{z} {P}_{{H}_{2} O}^{x}}{{P}_{CO}^{{s}_{s}} {P}_{{H}_{2}}^{{y}_{new}}}\end{matrix} \\ that is \text{:} \frac{{P}_{{C}_{{P}_{1}} {H}_{P 2}}^{z} {P}_{{H}_{2} O}^{x}}{{P}_{CO}^{{s}_{s}} {P}_{{H}_{2}}^{{y}_{new}}} = {e}^{- \frac{Δ {G}^{0}}{RT}}$$

If the initial pressure of gas reactants is Pᵢₙᵢ, then, at equilibrium, partial pressures will be given by:

P_{CO}=(Pᵢₙᵢ−sₛw);P_{H}_{₂}=(Pᵢₙᵢ−y_{new}w);P_{C}_{₁₂}_{H}_{₁₆}=zw;P_{H}_{₂}_{O}=xw

So the equation to solve is a transcendental polynomial of the form:

$$\frac{{( zw )}^{z} {( xw )}^{x}}{{( {P}_{ini} - {s}_{s} w )}^{{s}_{s}} {( {P}_{ini} - {y}_{new} w )}^{{y}_{new}}} = {e}^{- \frac{Δ {G}^{0}}{RT}}$$

Where w is the unknown to search for f(w)=0. With ΔHᵣ⁰=−155.54 kJ; ΔSᵣ⁰=−220.25 J/K; T=273+250° C.=523K We get: ΔGᵣ⁰=ΔHᵣ⁰−TΔSᵣ⁰=−35.119kJ

That is, ΔGᵣ⁰<0 means that the FT-diesel reaction is spontaneous at T=523K.
Now with: R=8.314J/K·mol; sₛ=x=1; z=0.083; y_{new}=2.083, and rearranging the equation to solve we get:

$$\frac{{( zw )}^{z} {( xw )}^{x}}{{( {P}_{ini} - {s}_{s} w )}^{{s}_{s}} {( {P}_{ini} - {y}_{new} w )}^{{y}_{new}}} = {e}^{- \frac{Δ {G}^{0}}{RT}} = {e}^{8.077} ⇔ \{ \begin{matrix}{aw}^{( 1 + a )} - 3219 ( {P}_{ini} - w ) {( {P}_{ini} - ( 2 + a ) w )}^{( 2 + a )} = 0 \\ a = 0.083\end{matrix}$$

the w values for which f(w)=0 are summarised in table 6.

TABLE 6

| | | | | |
|---|---|---|---|---|
| W | 14.3991 | 16.799 | 19.199 | 24 |
| Pi (bar) | 30 | 35 | 40 | 50 |
| PCO | 15.6009 | 18.201 | 20.801 | 26 |
| PH2 | 0.006675 | 0.007683 | 0.008483 | 0.008 |
| PC12H26 | 1.195125 | 1.394317 | 1.593517 | 1.992 |
| PH2O | 14.3991 | 16.799 | 19.199 | 24 |

At Pᵢₙᵢ = 30 bar, we get: P_{CO} = 15.6 bar, P_{H2} = 0.0067 bar, P_{C12H26} = 1.2 bar, P_{H2O} = 14.4 bar. At 250° C. and according with the thermodynamic properties of saturated steam-water only if P_{H2O} > 39.7 bar the steam will liquefy (→P_{H2O} disappears from equation of partial pressures at equilibrium). Even at Pᵢₙᵢ = 50 bar, P_{H2O} = 24 bar, well below the liquefaction threshold → the FT reactor at this pressure and T delivers steam (not liquid water). If T ≧ 374.15° C., no mater the pressure, H₂O is always steam (H₂O critical point is T_{c} = 374.15° C., P_{c} = 220.9 bar, V_{c} = 0.0568 m³/kmol). At T = 250° C., only for Pᵢₙᵢ > 82.7 bar we get P_{H2O} > 39.7 bar, that is, the water will liquefy.

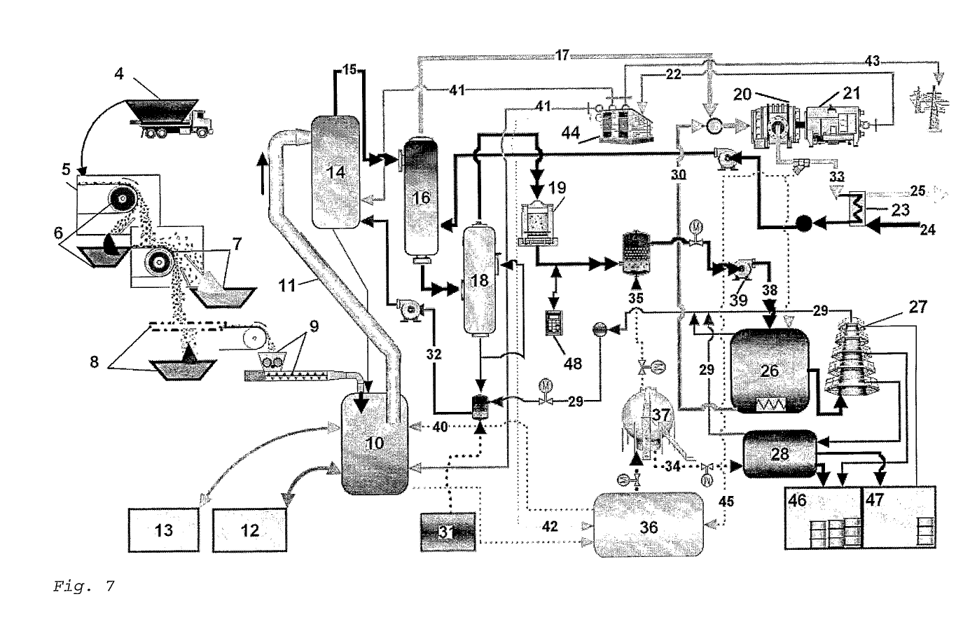

Lines (17, 30 and 33) in FIG. 7 show this steam connection between FT-reactor and SYNGAS cooling system and the Steam Turbine. See also chapter 4.3- below for a more comprehensive description on the associated energy (enthalpy) and mass balances.

### viii) Use Electricity Generated at The Local Steam Turbine Subsystem (3) to Feed All Local Refinery Needs, Including Local Generation of Hydrogen

Electricity generated at the electric power station of sub-system 3 is, together with the synthetic hydrocarbons, one of the most valuable output products of the present WTLH Refinery System. This electricity may either be used locally to cope with the WTLH refinery needs and/or for external sale to the electric grid. When used locally this electricity may fully feed the PETC (10) and Plasma Torch (14) needs, as well as all other smaller needs (like control systems, lights, etc) and its excess may further be used for local production of hydrogen (e.g. electrolytic hydrogen generation).

### ix) Use Stoichiometric Water Injection at the PETC Level, Instead of O₂, Both to Deliver Oxygen for CO Formation (as O₂ Injection Does) and Increase the Hydrogen Content in the Final SYNGAS

Instead of the standard injection of O₂ at the PETC level (to promote stoichiometric formation of CO), we can inject water (either as steam or liquid water), both to promote the stoichiometric formation of CO as well as the SYNGAS enrichment on H₂. This procedure may easily increase the usage ratio of H₂ to CO for the FT reactor and may be used as an alternative or simultaneously with the injection of pure H₂, as described in Case 3- of 4.2 i). In an energetic balance point of view this means that more energy will be consumed at the PETC (10) and/or the Plasma Reactor (14) level since the water molecule needs to be dissociated there. In fact, the water dissociation reaction enthalpy for the two water moles in equation 2H₂O(l)→2H₂(g)+O₂(g) is ΔHᵣ⁰=571.6 kJ. Calculating further the reaction entropy and Gibbs energy we get:

$$\{ \begin{matrix}{S}^{0} ( {H}_{2} O ( l ) ) = 69.9 J \text{/} K \cdot mol \\ {S}^{0} ( {O}_{2} ( g ) ) = 205.0 J \text{/} K \cdot mol \\ {S}^{0} ( {H}_{2} ( g ) ) = 131.0 J \text{/} K \cdot mol \\ \begin{matrix}Δ {S}_{r}^{0} = 2 {S}^{0} ( {H}_{2} ( g ) ) + {S}^{0} ( {O}_{2} ( g ) ) - 2 {S}^{0} ( {H}_{2} O ( l ) ) \\ = 327.2 J \text{/} K\end{matrix} \\ Δ {G}_{r}^{0} = Δ {H}_{r}^{0} - T Δ {S}_{r}^{0} = 420.09 kJ\end{matrix} \qquad ( 7 )$$

Since ΔGᵣ⁰>0 this means that water dissociation is an endothermic non-spontaneous process. For the reaction to happen, we need to deliver energy either as electricity and/or thermal energy up to: (571.6/2) kJ/mol*1000 kg/0.018 kg/mol=15.877 MJ/ton H₂O=4.4 MWh/ton H₂O. Since 1 ton H₂O has 111.11 kg of H₂ or 111.11 kg/0.0899 kg/Nm³H₂=1236 Nm³H₂ it means that a theoretical value of 3.56 kWh/Nm³H₂ (4400 kWh/1236 Nm³H₂) is required for water dissociation. If the PETC is used for water dissociation, then a minimum temperature of T=ΔHᵣ⁰/ΔSᵣ⁰≧1475° C. (when ΔGᵣ⁰≦0) is required.

### x) Use Excess Water Purged from the Steam Turbine Cycle to Inject it in the PETC and/or Electrolyse it and Generate H₂ (for i) and ii) and O₂ to Use Locally at the PETC

Steam (17 and 30) used by the Steam Turbine (20) of sub-system (3) (FIG. 4) comes both from SYNGAS cooling (16) and FT reactor (26). Since the FT reactor (26) generates water from SYNGAS, together with the synthetic hydrocarbon products (see equations (1), (3) and (5)), it is expected that water must be purged (54) from the Rankine cycle at the condenser component (23) level. This pure water may be used either for re-injection and dissociation into the PETC (10) (as described previously in ix) or for local water electrolysis using excess electricity generated by the sub-system (3) Steam Turbine. If water electrolysis is the chosen way to dissociate water and produce H₂ (g) for SYNGAS enrichment, then the O₂ (g) that is produced may also be used at PETC for stoichiometric CO generation.

### xi) Use Low Enthalpy Energy Input From Environment and Local Co-Generation Systems To Produce Hydrogen Locally

Low enthalpy (56) is available at different components of the WTLH Refinery System, particularly at the condenser stage of sub-system 3 (FIG. 4). The total energy required to dissociating water and generating hydrogen is, at least, 3.56 kWh/Nm³H₂. It can be achieved either using electricity (electrolysis), thermal energy (thermal water dissociation) or a combination of both. Co-generation heat from the Rankine cycle may be used to help building the water dissociation energy required.

### xii) Tailoring The Ft Reactor (26), The Distillation Column (27) and the Hydrocracking Reactor (28) for Variable % Generation of FT-Diesel and FT-Gasoline

In sub-system (2) (FIG. 3) SYNGAS (enriched or not) will be used to generate synthetic hydrocarbons. The normal outcome from the FT-reactor (26), Distillation Column (27) and Hydrocracking (28) components of such sub-system is a mix of hydrocarbon families, but making choices at the level of feedstock composition, operating temperatures, operating pressures, catalyst composition and promoter, SYNGAS composition and type of equipment, it is possible to tailoring the distribution output of hydrocarbon species formed. Although our WTLH Refinery System may be tuned to produce particular hydrocarbon species, like diesel and naphtha, it is clear and claimed that it can produce any type of hydrocarbon (including polymeric species) making the right above mentioned tailoring choices.

FIG. 7 summarises the whole WTLH—Waste to Liquid Hydrocarbon Refinery System case with options. Any hydrocarbon family member can be generated, but particular emphasis will be on diesel and naphtha. Options can be implemented alone or ensemble. Option inclusion will result in both production rate and total product volume increase. Other valuable output products will be the co-generated electricity and heat and the PETC vitrified slag (13) and metal ingots (12). Thus, the WTLH Refinery System may be seen as a poly-generation system.

### 4.3—Energy and Mass Balances of the Proposed WTLH Refinery System with or without its Modifications

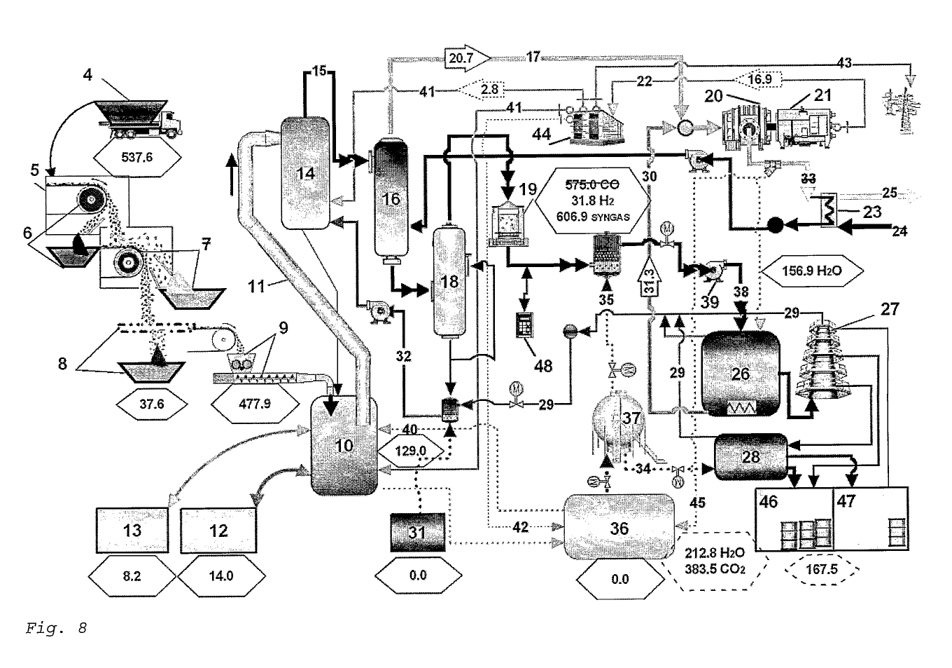

Putting together the whole set of equations that govern the WTLH Refinery System functioning, one can simulate its expected production as a function of feedstock choices. FIG. 8 summarises an example of such simulation for a partially-enriched SYNGAS case where water is feed to the FT-reactor (26) to allow WGS reaction to proceed with increased generation of H₂ (Case 2- of 4.2 i)). However no direct input of H₂ or Biogas is produced. As an example, for the particular feedstock composition choice i.e. 40% wood, 57% MSW, 0% Biogas, 2% old tires, 0% glycerine, 1% mineral oil, 0% coal and no hydrogen added to the SYNGAS (and/or water added to the PETC), we see that the 500 ton per day of PETC carbon containing feedstock, will allow to produce the equivalent to 167.5 toe/day (tons of oil equivalent per day) or 1222 boe/day (barrels of oil equivalent per day). It is also assumed that the original feedstock arriving to the WTLH refinery contains up to 7% (some 37.6 tons) of non-carbon containing materials (metals, glass, etc) and that only 95.6% of the PETC feedstock can be converted into SYNGAS. The remaining 4.4% of non-SYNGAS input material will be delivered by the PETC in the form of vitrified slag (8.2 ton/day) and metal ingots (14 ton/day). That is, only 477.9 tons/day of feedstock will be converted into original SYNGAS. Injecting 129 ton/day of O₂ in the PETC, will allow producing 575 ton/day of CO and 31.8 ton/day of H₂, that is, a total SYNGAS output from gasification sub-system 1 (FIG. 2) of 606.9 ton/day, or 1710 m³ SYNGAS/ton of feedstock. Adding 156.9 ton/day of H₂O for WGS will allow the production of 167.5 toe/day of FT products, 383.5 ton/day of CO₂ and 212.8 ton/day of H₂O as steam.

Mass balance is verified (606.9 ton/day of SYNGAS+156.9 ton/day of H₂O for WGS=167.5 toe/day of FT products+383.5 ton/day of CO₂+212.8 ton/day of H₂O as steam=763.8 ton/day of total mass).

On what concerns de energy balance, it shall be noted that the WTLH Refinery System has two major heat sources and two major heat sinks. Relevant heat sources are the SYNGAS cooling exchanger and the FT reactor. Relevant heat sinks are the PETC/PR and the Rankine steam cycle condenser after the Steam Turbine. Total enthalpy available to produce superheated steam with SYNGAS cooling may be evaluated using either the feedstock to SYNGAS reaction enthalpy or the difference between the Low Heat Value (LHV) content of feedstock and total SYNGAS LHV plus the energy delivered to the PETC/PR. Table 7 summarises this estimate for the operational values in FIG. 8. According with table 7 and FIG. 8, the total heat power available from SYNGAS cooling to sub-system 3 is given by (496.1 MWh/day)/24 h=20.7 MWt.

TABLE 7
Total enthalpy available to produce superheated steam with SYNGAS cooling for the WTLH refinery parameters considered in FIG. 8.

| | LHV | Heat contrib | Heat contrib | Heat contrib | Heat contrib | Electric. | Heat contrib | | |
|---|---|---|---|---|---|---|---|---|---|
| Energy Balance | Feedstock | Feedstock | from CO | from H2 | SYNGAS | Auto-com. | to ST | | |
| Feedstock to SYNGAS | MWh/ton | MWh/day | MWh/day | MWh/day | MWh/day | MWh/day | MWh/day | | |
| Dry Wood | 6.46 | 1235.811 | 656.118 | 387.215 | 1043.333 | 27.100 | 219.579 | Heat removal from | |
| MSW | 7.03 | 1914.323 | 995.419 | 626.620 | 1622.039 | 38.618 | 330.901 | hot SYNGAS | |
| Biogas | 14.55 | 0.000 | 0.000 | 0.000 | 0.000 | 0.000 | 0.000 | | |
| Old Tires | 10.74 | 102.647 | 60.802 | 24.089 | 84.891 | 1.355 | 19.111 | comming from PETC | |
| Glycerine | 6.48 | 0.000 | 0.000 | 0.000 | 0.000 | 0.000 | 0.000 | SYNGAS cooling | |
| Mineral Oil | 12.72 | 60.810 | 28.775 | 23.548 | 52.323 | 0.678 | 9.164 | 2200-550K contrib | |
| (mean: C25 H52) | | | | | | | | to ST (MWh/day) | |
| Coal | 9.67 | 0.000 | 0.000 | 0.000 | 0.000 | 0.000 | 0.000 | | |
| Mean | 6.93 | 3313.591 | 1741.114 | 1061.472 | 2802.586 | 67.751 | 578.755 | 496.142 | 563.893 |

First numerical column is LHV of feedstock in MWh/ton. Assuming the same percentage ratio for feedstock contribution as in FIG. 8, it is possible to estimate the daily LHV feedstock contribution to SYNGAS (numerical column 2 in MWh/day). Column 5 is total contribution to LHV of daily produced SYNGAS. Column 6 is the daily energy (electricity) delivered to the PETC/PR. The heat energy available to sub-system 3 is given by (column 2 − column 5 + column 6) = 578.8 MWH/day in current example. Assuming that SYNGAS cools from 2200 K to 550 K and that Specific Heat for CO is 1.08 kJ/kg · K and for H₂ is 14.5 kJ/kg · K a value of 496.1 MWh/day can be exchanged at the SYNGAS cooling system. Thermal heat efficiency from feedstock to SYNGAS is (2802.6 MWh/day)/(3313.6 MWh/day) ≈ 84.6%, while efficiency from hot SYNGAS to cooling exchanger is about 100* 496.1/578.8 = 85.7%.

The enthalpy contribution from FT-reactor (26) (sub-system 2) to the sub-system 3 (Rankine cycle) can be estimated using either the reaction equation enthalpy of SYNGAS to FT-products or the difference between LHV of input SYNGAS and the LHV of output FT-products. Considering that for the present choice of feedstock proportion, the CO content is 1.203 ton/ton feedstock and the original H₂ content (before adding H₂O for WGS) is 0.067 ton/ton feedstock, a SYNGAS LHV of 5864 kWh/ton feedstock is obtained (with a CO LHV of 10.9 MJ/kg and a H₂ LHV of 120.1 MJ/kg). Using solely C₁₂H₂₆ as the FT-product output reference, with a LHV of 44.12 MJ/kg, a total energy efficiency of SYNGAS to C₁₂H₂₆ of 73.2% is obtained ([44.12 MJ/kg*167.5 toe/day*1000/3.6]/[5864 kWh*477.9 ton/day]=0.732). Thus, 100%-73.2%=26.8% are left to be used as co-generated thermal power, or 31.3 MWt.

This is equivalent to estimate the reaction enthalpy of equation (3) for Case 2- above. In fact this may be written as:

ΔHᵣ⁰=[zΔH_{f}⁰(C₁₂H₂₆(l))+xΔH_{f}⁰(H₂O(g))+dsΔH_{f}⁰(CO₂(g))+dsΔH_{f}⁰(H₂(g))]−−[sₛΔH_{f}⁰(CO(g))+(yₛ+ds)ΔH_{f}⁰(H₂(g))+dsΔH_{f}⁰(H₂O(g))] (8)

with:

ΔH_{f}⁰(C₁₂H₂₆(l))=−290.9 kJ/mol

ΔH_{f}⁰(H₂O(g))=−241.8 kJ/mol

ΔH_{f}⁰(CO₂(g))=−393.5 kJ/mol

ΔH_{f}⁰(H₂(g))=0

ΔH_{f}⁰(CO(g))=−110.5 kJ/mol (9)

Using equations (8) and (9) we can calculate ΔHᵣ⁰ for each feedstock type (Table 8). For cobalt based catalysts the WGS reaction is negligible, but for iron catalysts WGS can have a significant effect on the composition of the gas inside the FT reactor and will happen to an extent that depends on the FT conditions. For lower temperatures (210 to 240° C.) the rate of WGS reaction is slow and only small amounts of CO₂ are formed. However, at higher temperatures (above 300° C.) the WGS rapidly proceeds to equilibrium. For the present simulation example purpose we will assume that only 55% of H₂O and CO will react to produce CO₂ and H₂ in equilibrium, that is, the reverse WGS reaction occurs, producing back CO, which then reacts further in the FT reaction. This is a way of converting CO₂ into FT products. So, the 55% WGS converted H₂O and CO into CO₂ and H₂ will release its formation heat into the FT reactor and the two WGS terms ds ΔH_{f}⁰(CO₂(g))+ds ΔH_{f}⁰(H₂(g)) of equation (8) shall be multiplied by 0.55. This way, numerical column 6 in table 8 represents for each feedstock type in kJ. The weighted mean value (according to our choice of waste composition) is ΔHᵣ⁰=−134.5 kJ, or 4.58 MWh/ton of C₁₂H₂₆ (column 7) or 766.6 MWh/day of total daily waste heat (column 8). The FT generated thermal power available for electrical co-generation at the Steam Turbine component of Sub-system 3 is then 766.6/24 h=31.9 MWt, which compares with the value of 31.3 MWt obtained previously using LHV arguments (the same value is obtained if the WGS conversion happens to an extent of 53.5%).

TABLE 8
Enthalpy of reaction for Case 2- mentioned above and total thermal
power available for the WTLH sub-system 3 (last column).
Ss CO + (Ys + ds) H2 + ds H2O −> Z (Cp1 Hp2) + X H2O + ds CO2 + ds H2
% of WGS converted H2O at equilibrium: 55.00%

| | | | | | | Released Energy at the FT reactor | | | |
|---|---|---|---|---|---|---|---|---|---|
| | | | | | | Del H0 | MWh/ton | Del H0 | Power t |
| | | | FT-Gasol. | H2O | | FT react | of | FT react | FT react |
| | Ss | Ys + ds | Z | X | ds | kJ | C₁₂H₂₆ | MWh/day | MWt |
| Dry Wood | 1 | 1.182 | 0.047 | 1 | 0.432 | −134.086 | 4.629 | 775.217 | 32.301 |
| MSW | 1 | 1.216 | 0.049 | 1 | 0.416 | −134.890 | 4.527 | 758.206 | 31.592 |
| Biogas | 1 | 2.000 | 0.080 | 1 | 0.040 | −153.557 | 3.134 | 524.876 | 21.870 |
| Old Tires | 1 | 1.016 | 0.041 | 1 | 0.512 | −130.119 | 5.229 | 875.621 | 36.484 |
| Glycerine | 1 | 1.577 | 0.063 | 1 | 0.243 | −143.473 | 3.715 | 622.116 | 25.921 |
| Mineral Oil | 1 | 1.378 | 0.055 | 1 | 0.338 | −138.752 | 4.109 | 688.159 | 28.673 |
| (mean: C25 H52) | | | | | | | | | |
| Coal | 1 | 0.916 | 0.037 | 1 | 0.560 | −127.738 | 5.693 | 953.449 | 39.727 |
| Weighted mean | | | | | | −134.512 | 4.578 | 766.658 | 31.944 |

If this FT thermal power is converted to steam and injected at Sub-system 3, an overall thermal power of [20.7 MWt (from SYNGAS cooling)+31.3 MWt (from FT)]=52 MWt can be achieved. With an assumed thermal to electrical efficiency conversion of 32.5%, a total electric power generation at the Steam Turbine of 16.9 MWe is expected (2.8 MWe for auto-consumption and the remaining either to be used locally for hydrogen generation or to be sold to the electric grid).

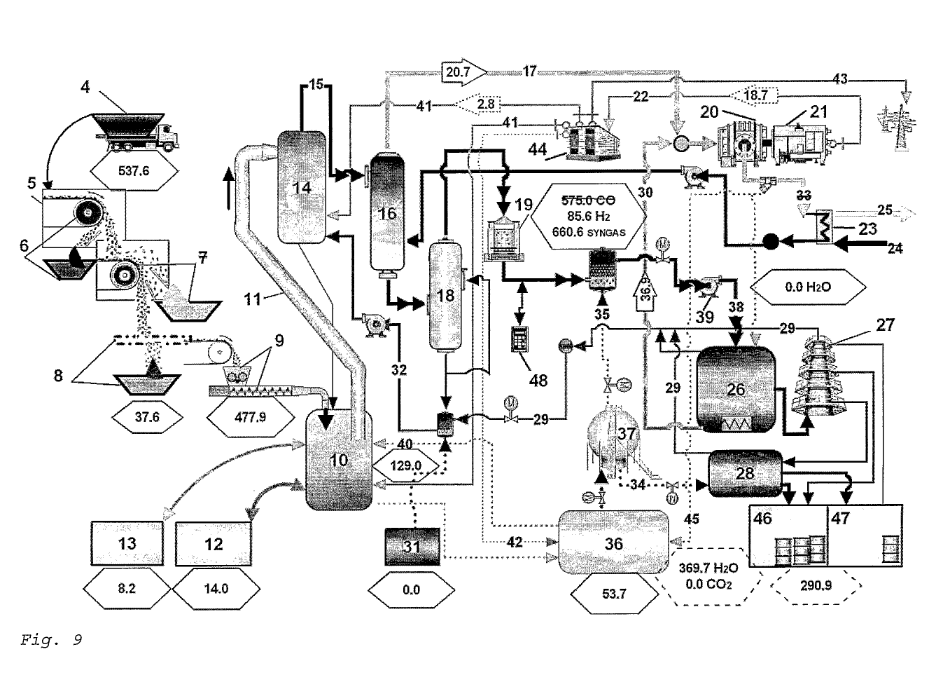

Proceeding similarly to Case 3- of 4.2 i), where H₂ is added to the original SYNGAS instead of promoting WGS, the results will change towards a significant increase of FT products generation. FIG. 9 summarises these simulation results for the same waste composition as in FIG. 8.

The gasification results in this SYNGAS enriched situation produces exactly the same results as in FIG. 8. That is, the same 477.9 tons/day of feedstock will be converted into original SYNGAS. Injecting 129 ton/day of O₂ in the PETC, will allow producing 575 ton/day of CO and 31.8 ton/day of H₂. However, extra H₂ is now added to enrich original SYNGAS (53.7 ton/day) and the final output of sub-system 1 becomes 660.6 ton/day, or 2970 m³ SYNGAS/ton of feedstock. No WGS will now be allowed to proceed. Now a total production of 290.9 toe/day of FT products and 369.7 ton/day of H₂O as steam can be achieved.

Using equations (5) and (6) we can calculate ΔHᵣ⁰ for each feedstock type (Table 9). The weighted mean value (according to our choice of waste composition) is now ΔHᵣ⁰=−155.5 kJ, or 3.05 MWh/ton of C₁₂H₂₆ (column 7 in table 9) or 886.7 MWh/day of total daily waste heat (column 8). The FT generated thermal power available for electrical co-generation at the Steam Turbine component of Sub-system 3 is then 886.7/24 h=36.9 MWt.

TABLE 9
Enthalpy of reaction for Case 3- of 4.2 i) (SYNGAS enriched with extra H₂) mentioned
above and total thermal power available for the WTLH sub-system 3 (last column).
Ss (CO) + Ynew (H2) −> Z (Cp1 Hp2) + X (H2O)

| | | | | | | Released Energy at the FT reactor | | | |
|---|---|---|---|---|---|---|---|---|---|
| | | | | | | Del HO | MWh/ton | Del H0 | Power t |
| | | | FT-Gasol. | H2O | | FT react | of | FT react | FT react |
| | Ss | Ynew | Z | Y H2RE | X | kJ | C₁₂H₂₆ | MWh/day | MWt |
| Dry Wood | 1.000 | 2.083 | 0.083 | 1.333 | 1.000 | −155.542 | 3.048 | 886.713 | 36.946 |
| MSW | 1.000 | 2.083 | 0.083 | 1.283 | 1.000 | −155.542 | 3.048 | 886.713 | 36.946 |
| Biogas | 1.000 | 2.083 | 0.083 | 0.123 | 1.000 | −155.542 | 3.048 | 886.713 | 36.946 |
| Old Tires | 1.000 | 2.083 | 0.083 | 1.580 | 1.000 | −155.542 | 3.048 | 886.713 | 36.946 |
| Glycerine | 1.000 | 2.083 | 0.083 | 0.750 | 1.000 | −155.542 | 3.048 | 886.713 | 36.946 |
| Mineral Oil | 1.000 | 2.083 | 0.083 | 1.043 | 1.000 | −155.542 | 3.048 | 886.713 | 36.946 |
| (mean: C25 H52) | | | | | | | | | |
| Coal | 1.000 | 2.083 | 0.083 | 1.728 | 1.000 | −155.542 | 3.048 | 886.713 | 36.946 |
| Weighted mean | | | | | | −155.542 | 3.048 | 886.713 | 36.946 |

If this FT thermal power is converted to steam and injected at Sub-system (3), an overall thermal power of [20.7 MWt (from SYNGAS cooling)+36.9 MWt (from FT)]=57.6 MWt can be achieved. With an assumed thermal to electrical efficiency conversion of 32.5%, a total electric power generation at the Steam Turbine of 18.7 MWe is expected (2.8 MWe for auto-consumption and the remaining either to be used locally for hydrogen generation or to be sold to the electric grid).

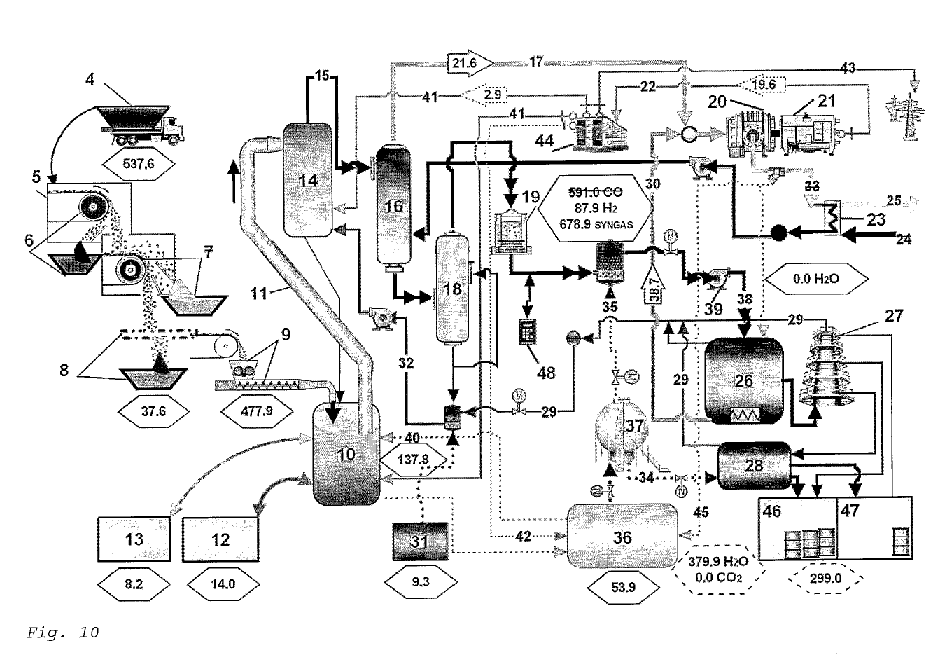

If a new simulation is performed now including Biogas (31) (FIG. 6) as the working gas at the Plasma Torch (32), a further increase of FT products will happen without increasing the previously installed (PETC/PR) gasification capacity (FIG. 10).

Assuming that a total of more 2% of feedstock purified Biogas at 98% methane enters into the WTLH refinery as Plasma Torch gas (about 9.3 ton/day of purified biogas), the final equivalent feedstock will become 102%. The total SYNGAS is now 678.9 ton/day and the total FT production is 299.0 toe/day or 2182.5 boe/day. The total heat energy available for the Steam Turbine is now 21.6 MWt from gasification and 38.7 MWt from the FT synthesis, or, 60.3 MWt at total. The electrical power produced may now attain a value of 19.6 MWe.

Comparing the three simulations (FIGS. 8 to 10) we conclude that adding water, extra hydrogen and/or Biogas via the Plasma Torch will significantly increase the Waste to FT-diesel yield (in the examples from 167.7 toe/day up to 299.0 toe/day or about 80% increase). We claim that the proposed options to the WTLH base refinery represent a clear innovative advantage.

### 4.4—Economical Impact of the Proposed WTLH Refinery System and its Modifications

The production cost of diesel and gasoline as a function of feedstock and feedstock mix shows that adding our proposed options will reduce production cost (numerical column 4 in table 10) to values below present international market costs, referenced to June 2006 (numerical column 5 in table 10) of the equivalent fossil fuel refined counterparts.

TABLE 10
FT diesel production cost as a function of different feedstock choices.

| | | | | Product. | Market | |
|---|---|---|---|---|---|---|
| | | | | Cost | Price of | |
| | | | | [symbol] /liter of | FT | Anual Net |
| | FT yield | FT yield | FT yield | FT | Products | cash flow |
| Feedstock | (toe/year) | (boe/year) | (m3/year) | Product | ( [symbol] /liter) | (M [symbol] ) |
| 100% wood (no H2 added) | 41900.00 | 930.00 | 53717.9 | 0.30 | 0.70 | 37.60 |
| 100% wood (added external H2 at 1.5 [symbol] /kg H2) | 73850.00 | 1640.00 | 94679.5 | 0.45 | 0.70 | 66.28 |
| 100% wood (added external H2 at 0.8 [symbol] /kg H2) | 73850.00 | 1640.00 | 94679.5 | 0.33 | 0.70 | 66.28 |
| 100% wood (added local H2 at 0.7 kWhe/Nm3) | 73850.00 | 1640.00 | 94679.5 | 0.37 | 0.70 | 66.28 |
| 100% wood (added local H2 at 0.3 kWhe/Nm3) | 73850.00 | 1640.00 | 94679.5 | 0.27 | 0.70 | 66.28 |
| 100% MSW (no H2 added) | 44000.00 | 980.00 | 56410.3 | 0.24 | 0.42 | 23.69 |
| 100% MSW (added external H2 at 0.8 [symbol] /kg H2) | 75400.00 | 1675.00 | 96666.7 | 0.29 | 0.42 | 40.60 |
| 100% MSW (added local H2 at 0.3 kWhe/Nm3) | 75400.00 | 1675.00 | 96666.7 | 0.24 | 0.42 | 40.60 |
| 100% tires (no H2 added) | 62600.00 | 1390.00 | 80256.4 | 0.25 | 0.42 | 33.71 |
| 100% tires (added external H2 at 0.8 [symbol] /kg H2) | 128500.00 | 2850.00 | 164743.6 | 0.31 | 0.42 | 69.19 |
| 100% tires (added local H2 at 0.3 kWhe/Nm3) | 128500.00 | 2850.00 | 164743.6 | 0.25 | 0.42 | 69.19 |
| 100% coal (no H2 added) | 55800.00 | 1240.00 | 71538.5 | 0.28 | 0.42 | 30.05 |
| 100% coal (added external H2 at 0.8 [symbol] /kg H2) | 127000.00 | 2820.00 | 162820.5 | 0.33 | 0.42 | 68.38 |
| 100% coal (added local H2 at 0.3 kWhe/Nm3) | 127000.00 | 2820.00 | 162820.5 | 0.26 | 0.42 | 68.38 |
| 100% glycerine(no H2 added) | 45000.00 | 1000.00 | 57692.3 | 0.30 | 0.70 | 40.38 |
| 100% glycerine(added external H2 at 0.8 [symbol] /kg H2) | 59500.00 | 1320.00 | 76282.1 | 0.32 | 0.70 | 53.40 |
| 100% glycerine(added local H2 at 0.3 kWhe/Nm3) | 59500.00 | 1320.00 | 76282.1 | 0.29 | 0.70 | 53.40 |

Values in table 10 were obtained assuming a typical capex of about 120 M [symbol] , a mean typical running cost of 4 M [symbol] /year, a discount rate of 8%, a yearly availability of the whole WTLH refinery of 90% and a breakeven period of 10 years. It is also assumed that all locally generated electricity is used locally, not sold to the grid and that the feedstock is bought at a mean market price of 20 [symbol] /ton of feedstock. Market price of 0.42 [symbol] /l of FT diesel is for non-renewable SYNGAS feedstock and 0.70 [symbol] /l of FT diesel is for a renewable origin one. This production costs (column 4 of table 10) compares with other expected production costs of FT diesel from biomass (Biomass to Liquid) of 0.42 [symbol] /l (Harold B., 2003) and FT diesel from coal (Coal to Liquid) of 0.22 [symbol] /1 (Rentech Inc, 2005).

### 4.5—Problems that the Present WTLH Refinery System can Solve and Expected Positive Impacts

1—To better ensure safety stock of hydrocarbon fuels via its endogenous synthetic production. Safety stock provides protection against running out of stock during the time it takes to replenish inventory.

2—To help reducing greenhouse gas emissions and comply with Kyoto protocol. Fossil fuels are direct contributors to greenhouse gas emissions and are also responsible for most of the acid rain events and sea black tides. Synthetic hydrocarbon fuels from biomass origin will deliver short cycle Carbon Dioxide and have no net contribution for emissions under Kyoto protocol. Synthetic hydrocarbon fuels from biomass origin are 100% renewable fuels. Synthetic Diesel and gasoline generated in this way have better burning properties than its fossil fuel counterparts. These synthetic diesel and gasoline fuels will have, respectively, higher cetane and octane indexes than its fossil fuel counterparts, will be top quality fuels for any car engine, while no climate change CO₂ will be released and NOₓ emissions will be 30% lower than the present best ones from fossil fuels.

3—To help solving the environment problem created by Municipal Solid Wastes (MSW) and Hazardous Industrial Wastes (HIW) by eliminating the need of landfill deposits while avoiding the need for waste incineration and further eliminating the atmospheric, water and land contamination problems created by those. MSW and HIW will be direct feedstock for synthetic hydrocarbon generation. The controversial incineration method for waste elimination usually creates dioxin and furan toxins. Our refinery system will completely eliminate any non-recyclable waste stream, will not produce dioxins or furans, will be fully compatible with the EU emissions Directive 2000/76/EC of the European Parliament and of the Council, will produce added value products, mainly synthetic hydrocarbon fuels, specially diesel and gasoline, metal ingots and non leaching vitrified slag for civil construction.

4—To help reducing our energy dependence from fossil fuels and fossil fuels imports, namely our dependence from oil producers and its market prices. Endogenous synthetic hydrocarbon fuel production will be independent from fossil fuel production costs and if sold at the national market will reduce the need for oil imports.

5—To help reducing human desertification in rural and forest zones. The intensive use of biomass forest wastes (BFW) for endogenous synthetic hydrocarbon production will help to prevent forest fires and create new jobs in rural areas (for BFW delivery as renewable synthetic hydrocarbon feedstock).

6—To create a new industry and business of synthetic hydrocarbon fuel production, using carbon containing wastes and renewable biomass as feedstock, for the direct substitution of its fossil fuel counterparts. The presently proposed WTLH refinery system will be at the heart of such new industry and business.

7—To help complying with EU Directive 2003/30/EC of the European Parliament and of the Council, on the promotion of the use of biofuels or other renewable fuels for transport. When using biomass and the biodegradable fraction of wastes the resulting synthetic hydrocarbon will be fully compatible with this directive and may be called 2^{nd} generation biofuels. Since the transport sector accounts for more than 30% of final energy consumption in EU and this EU Directive sets at 20% the biofuel penetration target by 2020 (calculated on the basis of energy content, of all petrol and diesel for transport purposes placed on EU markets by 31 Dec. 2020) a total of about 150 Mtoe of biofuels per year will be required. It is anticipated that the present WTLH refinery will become of crucial importance to achieve such goals.

Other advantages of our WTLH FT diesel relatively to its fossil fuel equivalent can be summarised as follows:
i) Have no sulphur, aromatics, or metals and high cetane number (table 11).

TABLE 11
Comparison of diesel standard specifications with WTLH FT diesel properties.

| | Current ASTM D975 | EPA Diesel | Current EU - | |
|---|---|---|---|---|
| | standard | requirements | EN590 standard | Present |
| | specification for | after October | specification for | WTLH FT |
| Property | diesel fuels (US) | 2006 (US) | diesel fuels (EU) | diesel |
| Sulfur (PPM) | 500 | 15 | 50 | 0 |
| Aromatics (% | 35 | 35 | N/A | 0 |
| weight) | | | | |
| Cetane Number | 40 | 40 | 51 | >75 |

ii) Is non-toxic and biodegradable.
iii) Is a colourless fluid immiscible with water (<0.1%).
iv) Is fully compatible with existing markets and with existing infrastructure (pipelines, storage terminals, retail pumps).
v) Performs better than conventional diesel in existing engines (cetane number almost twice the conventional).
vi) Can be produced from any carbon containing feedstock with average yields 3 to 5 times greater than other equivalent FT producers (GTL, CTL and BTL).

In the Portuguese case, a mean annual reference for diesel and gasoline consumption is, respectively, 5.1 Mtoe/year and 1.8 Mtoe/year (some 75% on diesel and 25% on gasoline). The available Portuguese carbon containing waste feedstock and forest biomass residues may attain mean annual reference values of, respectively, 9 Mton/year (INPRI, 2003) and 2 Mton/year (from forest residues). The presently proposed refinery system will be able to produce a mean of 0.5 toe/ton of feedstock, or a annual mean total of up to 11*0.5=5.5 Mtoe/year, that is, 100*5.5/(5.1+1.8)≈80% of the present overall diesel and gasoline needs of Portugal. Furthermore, the presently proposed WTLH refinery will allow not only for a fuel production cost not greater than the mean fossil fuel counterpart but will also have a synergistic effect on local industries as technology providers. So, the present patent has the potential for a tremendous positive impact on the Portuguese economy and stock safety of fossil fuels. A similar impact can be anticipated for any other country.

1-30. (canceled)

31. A waste to liquid hydrocarbon refinery system adapted to transform at least one of (a) municipal solid wastes, (b) hazardous industrial wastes, (c) biomass, and (d) carbon containing feedstock into at least one of (a) a synthetic hydrocarbon, (b) diesel fuel, (c) gasoline, (d) electricity, (e) cogen heat, (f) methanol, and (g) an alcohol, comprising:
a waste and biomass gasification subsystem;
a Fischer-Tropsch hydrocarbon synthesis subsystem;
an electricity generation and heat co-generation subsystem adapted for energy auto-sustainability of the process; and
a hydrogen generation and injection subsystem.

32. The system according to claim 31, wherein the gasification subsystem includes a pyro-electric thermal converter and a plasma arc adapted for large scale processing of waste and biomass and adapted to ensure no environment emissions, the gasification subsystem further including:
a waste and biomass feedstock reception hangar with negative gauge pressure environment where the waste and biomass feedstock is discharged on a conveyor for preprocessing through a magnetic separation of ferromagnetic materials for recycling; an eddy current separator adapted to extract for recycling non-iron metals from the feedstock stream, a density separator adapted to remove glass and silica-like materials for recycling from the feedstock stream, the remaining carbon containing waste feedstock proceeding to a fourth step adapted for extrusion and size reduction of the feedstock stream materials;
a molten bed pyro-electric thermal converter reactor at a high temperature, up to 1500° C., and an high pressure, up to 25 bar, anaerobic molten iron environment adapted to transforms inorganic material into vitrified slag and metal ingots/nodules and adapted to perform a first gasification process on carbon-containing feedstock;
a combination of a cyclone particle/ash separator and a plasma arc reactor adapted to treat and clean synthetic gas coming out of the molten bed reactor by an electrical plasma arc at a high temperature, up to 5000° C., and adapted to perform a second stage gasification and completely eliminate all undesirable compounds separated at the cyclone, heat released by the electrical plasma usable for slag overheating and vitrification;
a gas cleaning line adapted to cool a synthetic gas stream coming out of the plasma arc reactor in a gas thermal exchanger and adapted to subject the synthetic gas stream to a quencher and scrubber cleaning process reactor for further washing and removal of remaining non H₂ or CO species and in which resulting wastes from the cleaning step will be at least one of (a) further transformed into added value products and reinjected into the plasma arc reactor for destruction via vitrification; and
an active CZnO filtering system adapted to perform a final cleaning and synthetic gas purification.

33. The system according to claim 31, further comprising:
a new hydrogen generation and injection subsystem adapted to locally generate hydrogen up to a convenient predefined amount and premix with syngas flowing out from the gas cleaning line in a gas mixing buffer in which both gases are injected at a convenient pressure in order to achieve a most favorable partial pressure ratio for target hydrocarbon products prior to entering the Fischer-Tropsch reactor.

34. The system according to claim 33, wherein the new hydrogen generation and injection subsystem is adapted to locally generate hydrogen by splitting by-product water coming out from the Fischer-Tropsch reactor and from the biogas generation process, energy required for water splitting being partly derived from an electricity output of the electricity generation and heat co-generation subsystem and remaining energy coming from a gasification heat exchanger and power cycle condenser enthalpy together with an environment low enthalpy.

35. The system according to claim 34, wherein the air is extracted from the feedstock stream to reduce syngas diluents content and oxygen required for gasification is delivered directly by the hydrogen generation subsystem.

36. The system according to claim 33, wherein the Fischer Tropsch hydrocarbon synthesis subsystem includes:
a Fischer-Tropsch synthesis reactor, in which synthetic gas will give rise to at least one of (a) hydrocarbon compounds, (b) water, and (c) coal via chemical reactions catalyzed by cobalt/iron dominated catalysts; and the Fischer-Tropsch synthesis reactor arranged as a boiler of the electricity generation and heat co-generation subsystem;
a standard refinery fractional distillation device adapted to isolate targeted hydrocarbons from the hydrocarbon products coming out of the Fischer-Tropsch reactor;
a standard hydro-cracking device adapted to split off heavier wax products into lighter diesel and gasoline products.

37. The system according to claim 36, wherein the hydrogen generation subsystem is adapted to generate extra hydrogen for the hydro-cracking device.

38. The system according to claim 37, wherein at least one of (a) un-reacted synthetic gas and (b) undesired products coming out of the refinery hydrocarbon synthesis subsystem, jointly designated as tail gas, are re-injected into the plasma arc reactor of the gasification subsystem to convert them again into clean synthetic gas for further use as synthetic hydrocarbon feedstock.

39. The system according to claim 36, wherein a total steam resulting from adding the steam formed by the synthetic gas cooling device of the gasification subsystem to the steam formed by the hydrocarbon synthesis reactor in its boiler function are adapted to feed a steam turbine of a Rankine thermodynamic cycle to produce mechanical energy and low enthalpy convertible into electricity at a generator used to meet electric needs of the whole refinery system and whose energy excess, both thermal and electrical, is at least one of (a) usable to ensure energy auto-sustainability of the whole system and (b) salable to a grid.

40. The system according to claim 39, wherein a final low enthalpy resulting from a condenser component of the thermodynamic cycle is further cogenerated and used at a pre-processing stage of the organic feedstock to reduce water content.

41. The system according to claim 39, wherein in the power sub-system the addition of the hydrogen and the amount of extra thermal energy released at the Fischer-Tropsch synthesis process, is enough to attain a steam production capable of operating a conventional steam turbine.

42. The system according to claim 31, wherein in order to bring an original synthetic gas ratio close to an ideal usage ratio in the Fischer-Tropsch reactor, the CO content is lowered forming CO₂ and gasify formed H₂O from the hydrocarbon synthesis reaction or increase the H₂ content by injecting it into the original synthetic gas.

43. The system according to claim 31, wherein any waste mix feedstock, including hazardous industrial wastes, is usable without any kind of emissions into the environment because all byproducts will be either reused or removed and gas cleaning chemical solutions as market valuable products, persistent residues returning repeatedly to the plasma reactor from other units in all sub-systems being periodically removed and injected into the pyro-electric thermal converter to be specifically converted into a vitrified non-leachable and inert slag.

44. The system according to claim 31, wherein a biogas generation unit is adapted to deliver biogas to be used at least one of (a) as a feedstock, (b) as a working gas in a plasma torch, (c) inside a plasma reactor, and (c) directly inside the pyro-electric thermal converter.

45. The system according to claim 31, wherein water used in a gas cleaning process is totally recycled and reused after purification both for hydrogen generation and re-injection into a scrubber-quenching reactor.

46. The system according to claim 31, further comprising an automatic control system adapted to define a feedstock mix composition to optimize final yields of targeted synthetic hydrocarbon species.
